(19) United States
(12) Patent Application Publication
(10) Pub. No.: US 2025/0358076 A1
(43) Pub. Date: Nov. 20, 2025

(54) BANDWIDTH PART OPERATIONS FOR SMALL DATA TRANSMISSION PROCEDURES OF A REDUCED CAPABILITY USER EQUIPMENT

(71) Applicant: QUALCOMM Incorporated, San Diego, CA (US)

(72) Inventors: Jing LEI, San Diego, CA (US); Ruiming ZHENG, Beijing (CN); Linhai HE, San Diego, CA (US)

(21) Appl. No.: 18/869,660

(22) PCT Filed: Jul. 29, 2022
(86) PCT No.: PCT/CN2022/108819

§ 371 Date: Nov. 26, 2024

(51) Int. Cl. H04L 5/00; H04W 8/24

(52) U.S. Cl. CPC H04L 5/0053; H04W 8/24

(57) ABSTRACT

Various aspects of the present disclosure generally relate to wireless communication. In some aspects, a user equipment (UE) may receive, from a network node, information configuring a default initial downlink bandwidth part, wherein the default initial downlink bandwidth part includes downlink resources that support small data transmission (SDT) for reduced capability (RedCap) and non-RedCap UEs. The UE may receive, from the network node, information configuring a control resource set (CORESET) and one or more search space sets that support SDT for RedCap UEs. The UE may perform, while in a radio resource control (RRC) inactive or idle mode, an SDT based at least in part on the information configuring the default initial downlink bandwidth part and the information configuring the CORESET and the one or more search space sets. Numerous other aspects are described.

### FIELD OF THE DISCLOSURE

Aspects of the present disclosure generally relate to wireless communication and to techniques and apparatuses for bandwidth part operations for small data transmission (SDT) procedures of a reduced capability (RedCap) user equipment (UE).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a network node, information configuring a default initial downlink bandwidth part, wherein the default initial downlink bandwidth part includes downlink resources that support small data transmission (SDT) for reduced capability (RedCap) and non-RedCap UEs. The method may include receiving, from the network node, information configuring a control resource set (CORESET) and one or more search space sets that support SDT for RedCap UEs. The method may include performing, while in a radio resource control (RRC) inactive or idle mode, an SDT based at least in part on the information configuring the default initial downlink bandwidth part and the information configuring the CORESET and the one or more search space sets.

Some aspects described herein relate to a method of wireless communication performed by a network node. The method may include transmitting, to a UE, information configuring a default initial downlink bandwidth part, wherein the default initial downlink bandwidth part includes downlink resources that support SDT for RedCap and non-RedCap UEs. The method may include transmitting, to the UE, information configuring a CORESET and one or more search space sets that supports SDT for RedCap UEs. The method may include communicating with the UE while the UE is performing an SDT in an RRC inactive or idle mode based at least in part on the information configuring the default initial downlink bandwidth part and the information configuring the CORESET and the one or more search space sets.

Some aspects described herein relate to a UE for wireless communication. The UE may include memory, one or more processors coupled to the memory, and instructions stored in the memory and executable by the one or more processors. The instructions may be executable by the one or more processors to cause the UE to receive, from a network node, information configuring a default initial downlink bandwidth part, wherein the default initial downlink bandwidth part includes downlink resources that support SDT for RedCap and non-RedCap UEs. The instructions may be executable by the one or more processors to cause the UE to receive, from the network node, information configuring a CORESET and one or more search space sets that support SDT for RedCap UEs. The instructions may be executable by the one or more processors to cause the UE to perform, while in an RRC inactive or idle mode, an SDT based at least in part on the information configuring the default initial downlink bandwidth part and the information configuring the CORESET and the one or more search space sets.

Some aspects described herein relate to a network node for wireless communication. The network node may include memory, one or more processors coupled to the memory, and instructions stored in the memory and executable by the one or more processors. The instructions may be executable by the one or more processors to cause the network node to transmit, to a UE, information configuring a default initial downlink bandwidth part, wherein the default initial downlink bandwidth part includes downlink resources that support SDT for RedCap and non-RedCap UEs. The instructions may be executable by the one or more processors to cause the network node to transmit, to the UE, information configuring a CORESET and one or more search space sets that supports SDT for RedCap UEs. The instructions may be executable by the one or more processors to cause the network node to communicate with the UE while the UE is performing an SDT in an RRC inactive or idle mode based at least in part on the information configuring the default initial downlink bandwidth part and the information configuring the CORESET and the one or more search space sets.

Some aspects described herein relate to a non-transitory computer-readable medium that stores one or more instructions for wireless communication by a UE. The one or more instructions, when executed by one or more processors of the UE, may cause the UE to receive, from a network node, information configuring a default initial downlink bandwidth part, wherein the default initial downlink bandwidth part includes downlink resources that support SDT for RedCap and non-RedCap UEs. The one or more instructions, when executed by one or more processors of the UE, may cause the UE to receive, from the network node, information configuring a CORESET and one or more search space sets that support SDT for RedCap UEs. The one or more instructions, when executed by one or more processors of the UE, may cause the UE to perform, while in an RRC inactive or idle mode, an SDT based at least in part on the information configuring the default initial downlink bandwidth part and the information configuring the CORESET and the one or more search space sets.

Some aspects described herein relate to a non-transitory computer-readable medium that stores one or more instructions for wireless communication by a network node. The one or more instructions, when executed by one or more processors of the network node, may cause the network node to transmit, to a UE, information configuring a default initial downlink bandwidth part, wherein the default initial downlink bandwidth part includes downlink resources that support SDT for RedCap and non-RedCap UEs. The one or more instructions, when executed by one or more processors of the network node, may cause the network node to transmit, to the UE, information configuring a CORESET and one or more search space sets that supports SDT for RedCap UEs. The one or more instructions, when executed by one or more processors of the network node, may cause the network node to communicate with the UE while the UE is performing an SDT in an RRC inactive or idle mode based at least in part on the information configuring the default initial downlink bandwidth part and the information configuring the CORESET and the one or more search space sets.

Some aspects described herein relate to an apparatus for wireless communication. The apparatus may include means for receiving, from a network node, information configuring a default initial downlink bandwidth part, wherein the default initial downlink bandwidth part includes downlink resources that support SDT for RedCap and non-RedCap UEs. The apparatus may include means for receiving, from the network node, information configuring a CORESET and one or more search space sets that support SDT for RedCap UEs. The apparatus may include means for performing, while in an RRC inactive or idle mode, an SDT based at least in part on the information configuring the default initial downlink bandwidth part and the information configuring the CORESET and the one or more search space sets.

Some aspects described herein relate to an apparatus for wireless communication. The apparatus may include means for transmitting, to a UE, information configuring a default initial downlink bandwidth part, wherein the default initial downlink bandwidth part includes downlink resources that support SDT for RedCap and non-RedCap UEs. The apparatus may include means for transmitting, to the UE, information configuring a CORESET and one or more search space sets that supports SDT for RedCap UEs. The apparatus may include means for communicating with the UE while the UE is performing an SDT in an RRC inactive or idle mode based at least in part on the information configuring the default initial downlink bandwidth part and the information configuring the CORESET and the one or more search space sets.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIGS. 3A-3C are diagrams illustrating examples of mobile-originated small data transmission (MO-SDT) procedures, in accordance with the present disclosure.

FIGS. 4A-4B are diagrams illustrating examples of random access small data transmission (RA-SDT) procedures, in accordance with the present disclosure.

FIGS. 5A-5C are diagrams illustrating examples of mobile-terminated small data transmission (MT-SDT) procedures, in accordance with the present disclosure.

FIG. 6 is a diagram illustrating examples of an initial bandwidth part configuration for a reduced capability (RedCap) UE, in accordance with the present disclosure.

FIGS. 7A-7E are diagrams illustrating examples associated with downlink bandwidth part configurations for small data transmission (SDT) procedures of a RedCap UE, in accordance with the present disclosure.

FIG. 8 is a diagram illustrating an example associated with uplink bandwidth part configurations for SDT procedures of a RedCap UE, in accordance with the present disclosure.

FIG. 9 is a diagram illustrating an example associated with bandwidth part switching during an SDT procedure of a RedCap UE, in accordance with the present disclosure.

FIGS. 10-11 are diagrams illustrating example processes associated with bandwidth part operations for SDT procedures of a RedCap UE, in accordance with the present disclosure.

FIGS. 12-13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

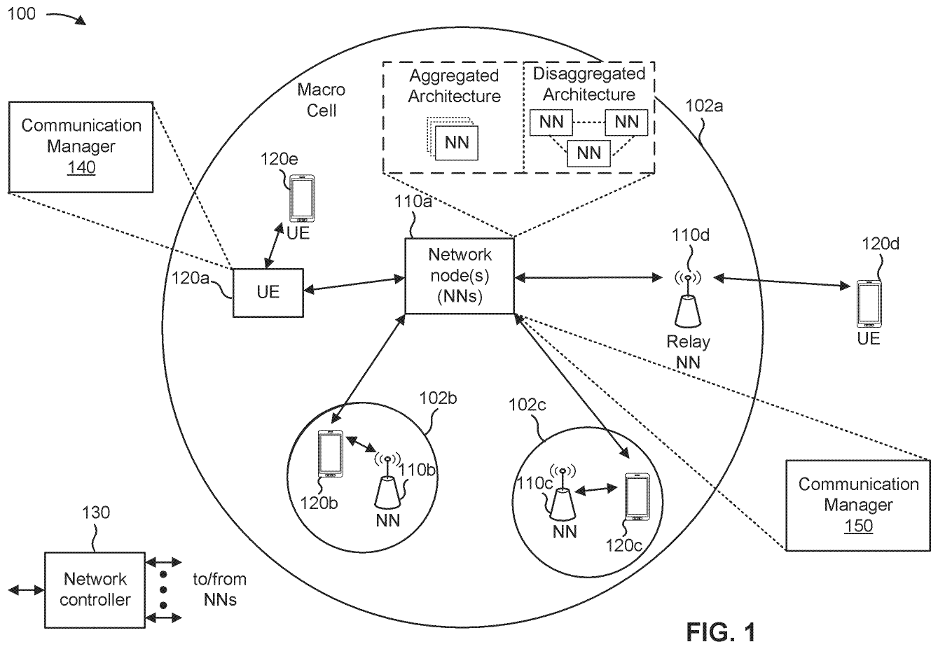

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node 110, information configuring a default initial downlink bandwidth part, wherein the default initial downlink bandwidth part includes downlink resources that support small data transmission (SDT) for reduced capability (RedCap) and non-RedCap UEs; receive, from the network node, information configuring a control resource set (CORESET) and one or more search space sets that support SDT for RedCap UEs; and perform, while in a radio resource control (RRC) inactive or idle mode, an SDT based at least in part on the information configuring the default initial downlink bandwidth part and the information configuring the CORESET and the one or more search space sets. Additionally, or alternatively, the communication manager 140 may perform one or more other operations described herein.

In some aspects, the network node 110 may include a communication manager 150. As described in more detail elsewhere herein, the communication manager 150 may transmit, to a UE 120, information configuring a default initial downlink bandwidth part, wherein the default initial downlink bandwidth part includes downlink resources that support SDT for RedCap and non-RedCap UEs; transmit, to the UE, information configuring a CORESET and one or more search space sets that supports SDT for RedCap UEs; and communicate with the UE 120 while the UE 120 is performing an SDT in an RRC inactive or idle mode based at least in part on the information configuring the default initial downlink bandwidth part and the information configuring the CORESET and the one or more search space sets. Additionally, or alternatively, the communication manager 150 may perform one or more other operations described herein.

As indicated above, FIG. 1 is provided as an example. Other examples may differ from what is described with regard to FIG. 1.

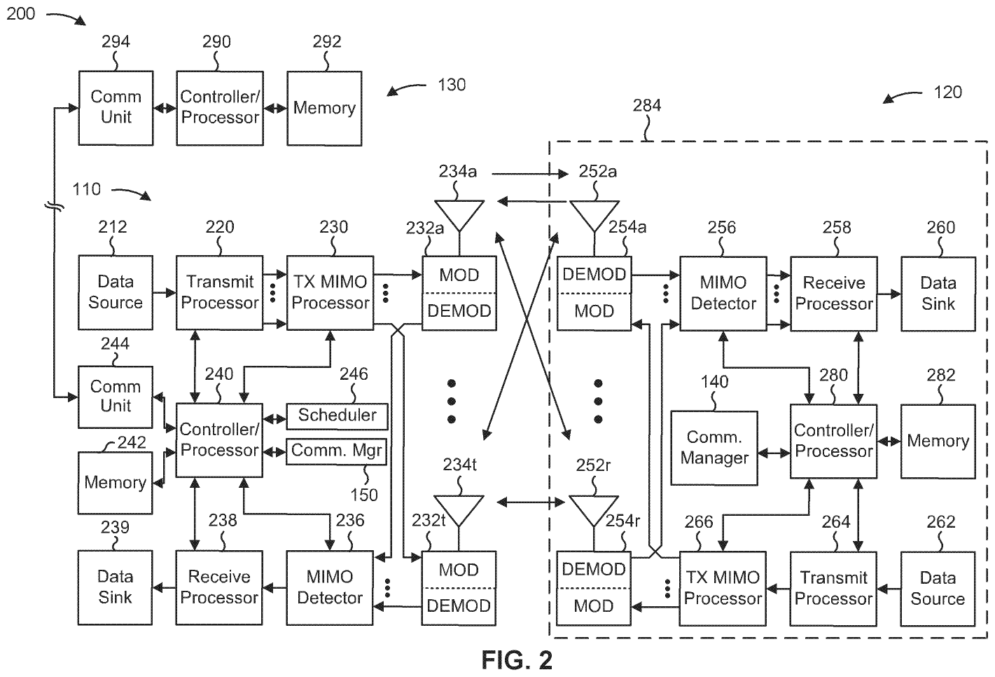

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

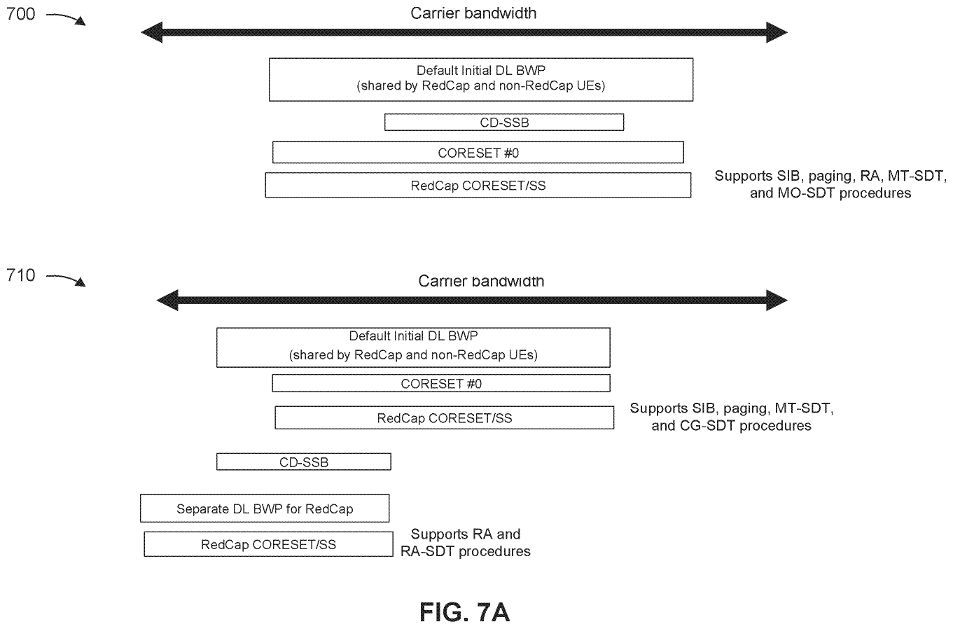

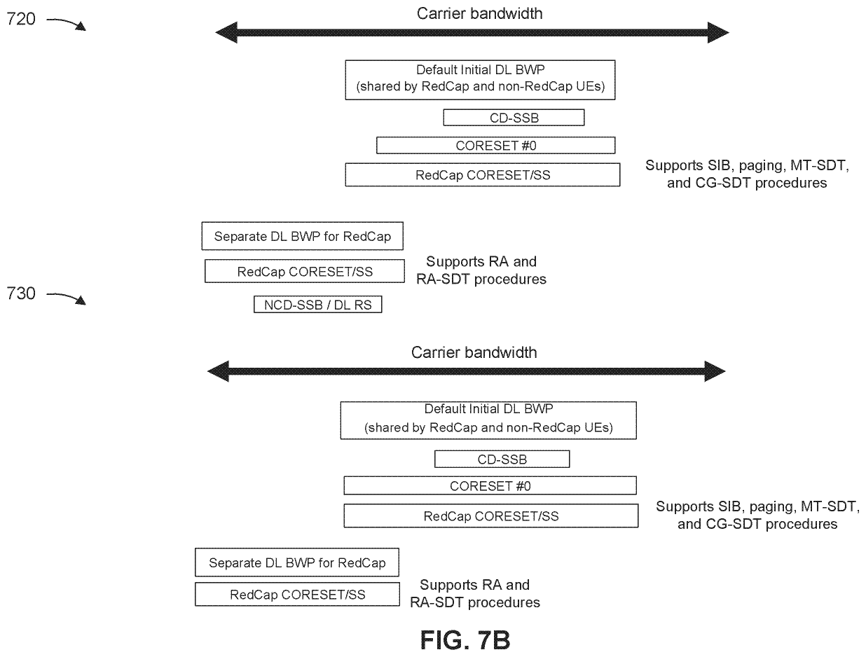

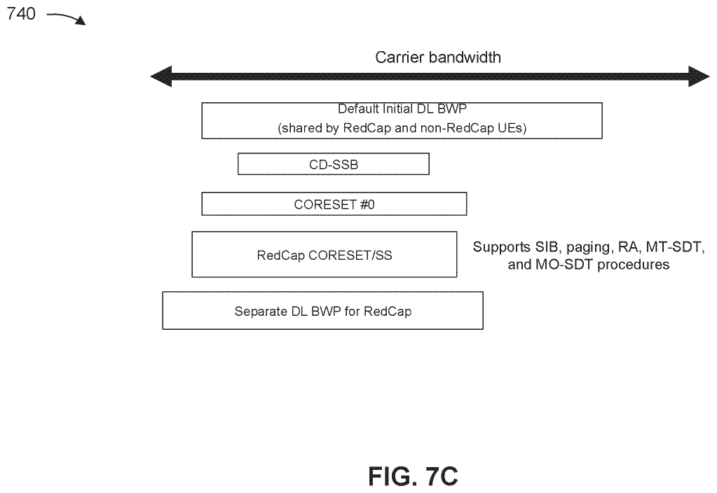

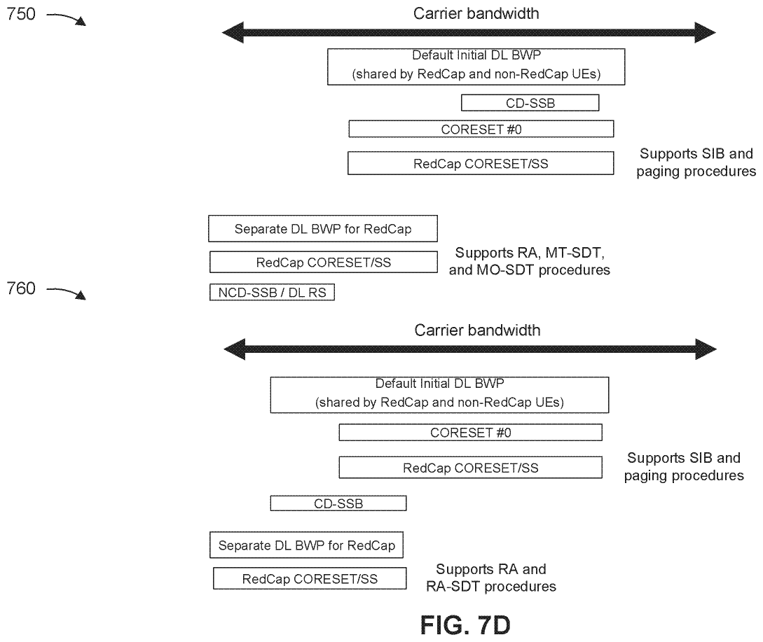

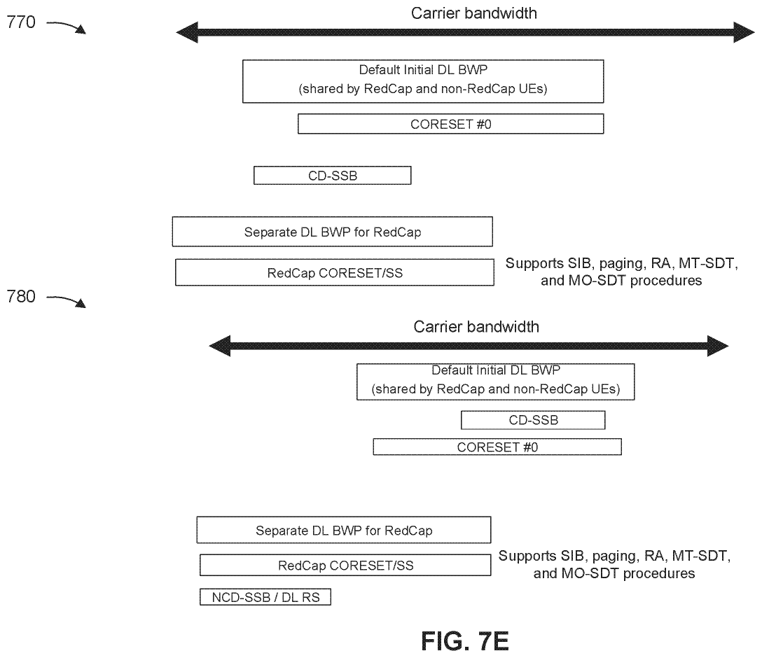

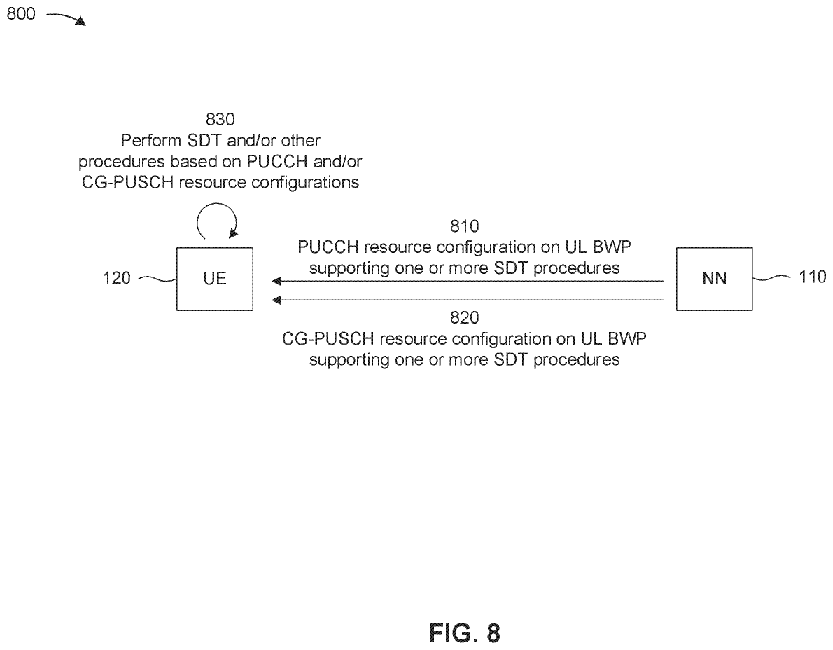

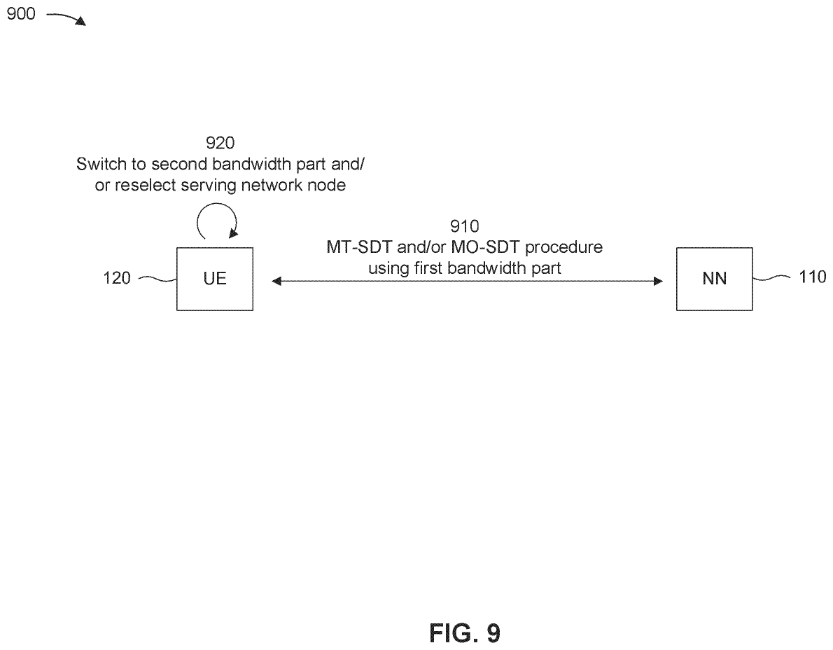

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-7E, FIG. 8, and/or FIG. 9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-7E, FIG. 8, and/or FIG. 9).

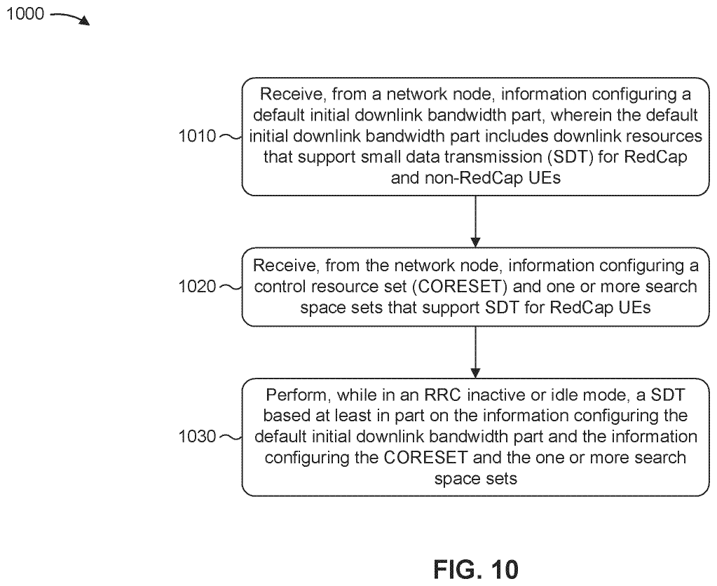

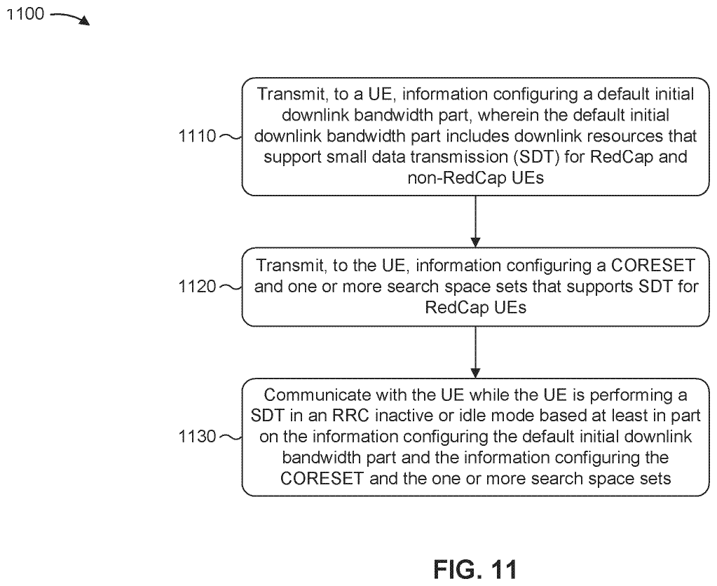

The controller/processor 240 of the network node 110, the controller/processor 280 of the UE 120, and/or any other component(s) of FIG. 2 may perform one or more techniques associated with bandwidth part operations for SDT procedures of a RedCap UE, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving, from a network node 110, information configuring a default initial downlink bandwidth part, wherein the default initial downlink bandwidth part includes downlink resources that support SDT for RedCap and non-RedCap UEs; means for receiving, from the network node 110, information configuring a CORESET and one or more search space sets that support SDT for RedCap UEs; and/or means for performing, while in an RRC inactive or idle mode, an SDT based at least in part on the information configuring the default initial downlink bandwidth part and the information configuring the CORESET and the one or more search space sets. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120, information configuring a default initial downlink bandwidth part, wherein the default initial downlink bandwidth part includes downlink resources that support SDT for RedCap and non-RedCap UEs; means for transmitting, to the UE 110, information configuring a CORESET and one or more search space sets that supports SDT for RedCap UEs; and/or means for communicating with the UE 120 while the UE 120 is performing an SDT in an RRC inactive or idle mode based at least in part on the information configuring the default initial downlink bandwidth part and the information configuring the CORESET and the one or more search space sets. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

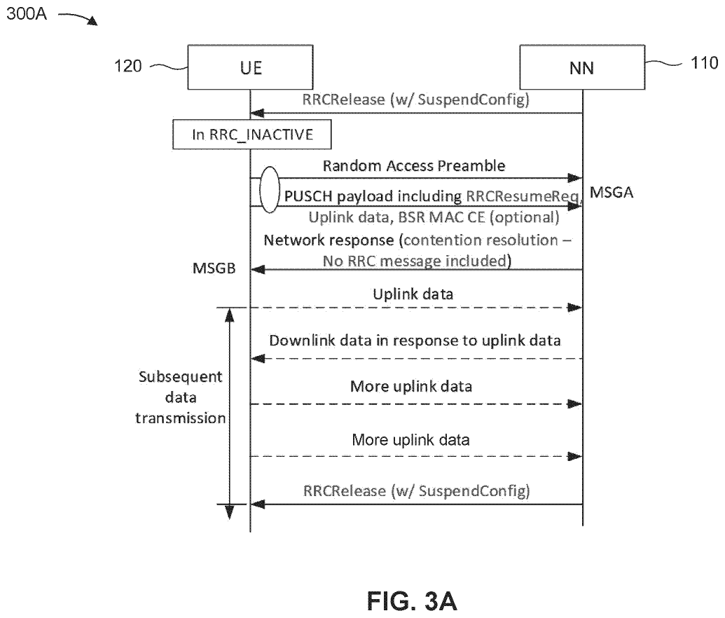

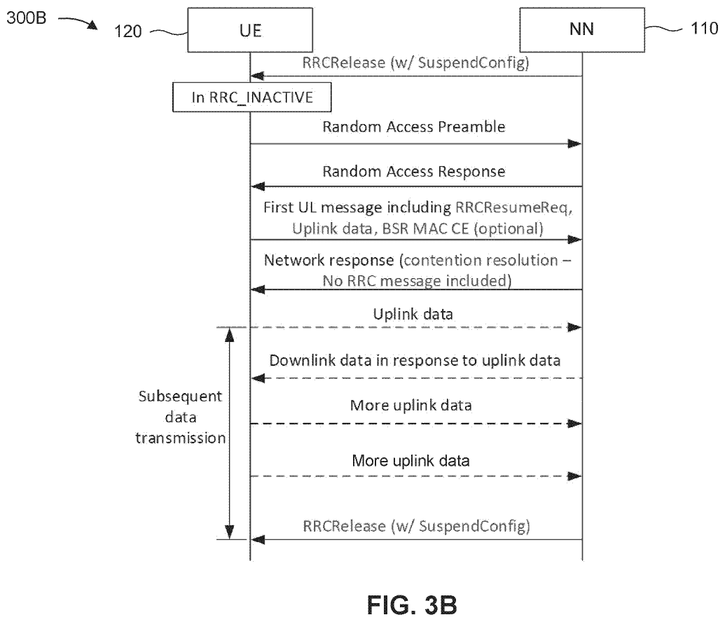

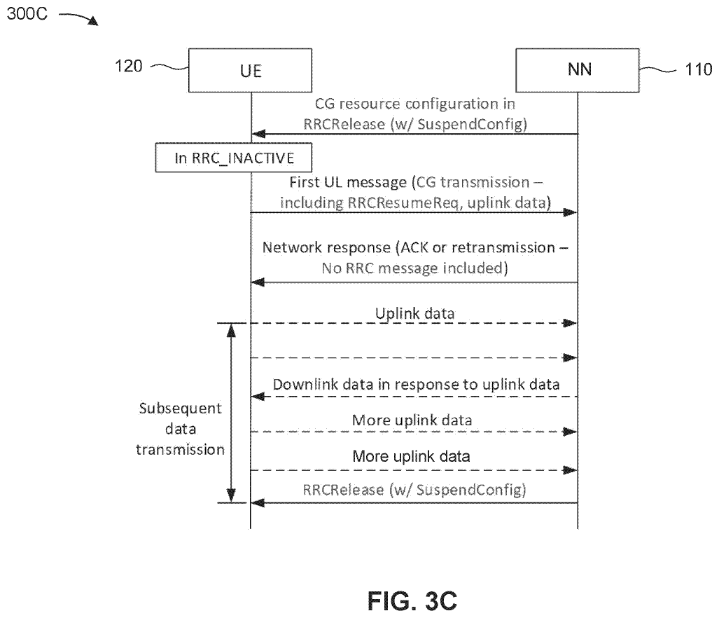

FIGS. 3A-3C are diagrams illustrating examples 300A-300C of mobile-originated small data transmission (MO-SDT) procedures, in accordance with the present disclosure. As shown in FIGS. 3A-3C, examples 300A-300C include communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As described herein, the network node 110 and the UE 120 may communicate in a wireless network that supports one or more MO-SDT procedures, which generally allow the UE 120 to transmit mobile-originated uplink small data (e.g., an uplink transmission having a payload size that is less than or equal to a threshold and/or subsequent uplink control information) while the UE 120 is in an RRC inactive or an RRC idle state without the UE 120 having to transition to an RRC connected state. In general, as described herein, the uplink small data may originate from a control plane or a data plane. For example, when the UE 120 switches from the RRC connected state to the RRC inactive or RRC idle state, the UE 120 may establish a data radio bearer (DRB) to transmit uplink small data that originates from the data plane. Additionally, or alternatively, the network node 110 may configure one or more signaling radio bearers (SRBs) to transfer non-access stratum (NAS) messages from the control plane.

For example, example 300A in FIG. 3A depicts a random access (RA)-based SDT procedure that allows the UE 120 to perform an uplink SDT from an RRC inactive or an RRC idle state during a two-step RACH procedure. For example, as shown in FIG. 3A, the network node 110 may transmit an RRC release message to the UE 120 with a suspend configuration parameter enabled, which may cause the UE 120 to transition to the RRC inactive or idle state. In cases where the UE 120 has uplink data to transmit and the uplink data has a payload size that fails to satisfy (e.g., is less than or equal to a threshold), the UE 120 may initiate a two-step RACH procedure from the RRC inactive or idle state in order to transmit the uplink small data. For example, as shown, the UE 120 may transmit a msgA communication, which includes a random access preamble and a physical upload shared channel (PUSCH) payload that includes an RRC resume request and the uplink small data. In some cases, the PUSCH payload may also include a buffer status report (BSR) medium access control (MAC) control element (MAC-CE). As further shown, the network node 110 may then transmit a msgB communication including a network response to the UE 120, where the msgB communication may include a contention resolution message with no RRC message included. For example, the network response may be used to control subsequent transmissions of uplink small data by the UE 120 and/or downlink small data to the UE 120 as well as state transition decisions between any subsequent SDTs. For example, as shown, the network node 110 may transmit an RRC release message with the suspend configuration parameter enabled to terminate the uplink and/or downlink SDTs.

Additionally, or alternatively, example 300B in FIG. 3B depicts an RA-based SDT procedure that allows the UE 120 to perform an uplink SDT from an RRC inactive or an RRC idle state during a four-step RACH procedure. For example, as shown in FIG. 3B, the network node 110 may transmit an RRC release message to the UE 120 with a suspend configuration parameter enabled, which may cause the UE 120 to transition to the RRC inactive or idle state. In cases where the UE 120 has uplink data to transmit and the uplink data has a payload size that fails to satisfy (e.g., is less than or equal to a threshold), the UE 120 may initiate a four-step RACH procedure from the RRC inactive or idle state in order to transmit the uplink small data. For example, as shown, the UE 120 may transmit a msg1 communication that includes a random access preamble to the network node 110, and the network node 110 may then transmit a msg2 communication that includes a random access response message to the UE 120. The UE 120 may then transmit a first uplink message in a msg3 communication, where the first uplink message includes an RRC resume request and the uplink small data. As further shown, the network node 110 may then transmit a msg4 communication including a network response to the UE 120, where the msg4 communication may include a contention resolution message with no RRC message included. For example, the network response may be used to control subsequent transmissions of uplink small data by the UE 120 and/or downlink small data to the UE 120 as well as state transition decisions between any subsequent SDTs. For example, as shown, the network node 110 may transmit an RRC release message with the suspend configuration parameter enabled to terminate the uplink and/or downlink SDTs.

Additionally, or alternatively, example 300C in FIG. 3C depicts an SDT procedure that allows the UE 120 to use a configured grant (CG) to perform an uplink SDT from an RRC inactive or an RRC idle state, whereby example 300C may be referred to herein as a CG-SDT procedure. For example, as shown in FIG. 3C, the network node 110 may transmit a CG resource configuration that includes one or more CG resource sets that include preconfigured PUSCH resources that can be used to transmit uplink data without an uplink grant (e.g., reusing a CG type 1 configuration). As shown, the CG resource configuration may be included in an RRC release message that is transmitted to the UE 120 with a suspend configuration parameter enabled, which may cause the UE 120 to transition to the RRC inactive or idle state. In cases where the UE 120 has uplink data to transmit and the uplink data has a payload size that fails to satisfy (e.g., is less than or equal to a threshold), the UE 120 may use the preconfigured PUSCH resources to transmit a first uplink message, where the first uplink message is a CG transmission that includes an RRC resume request and the uplink small data. As further shown, the network node 110 may then transmit a network response to the UE 120, where the network response may include an acknowledgement (ACK) or a request for a retransmission with no RRC message included in the network response. For example, the network response may be used to control subsequent transmissions of uplink small data by the UE 120 and/or downlink small data to the UE 120 as well as state transition decisions between any subsequent SDTs. For example, as shown, the network node 110 may transmit an RRC release message with the suspend configuration parameter enabled to terminate the uplink and/or downlink SDTs.

In general, the CG-SDT procedure depicted in FIG. 3C may differ from the RA-based SDT procedures depicted in FIGS. 3A-3B in terms of whether uplink timing is maintained during the applicable MO-SDT procedure. For example, in the RA-based SDT procedures depicted in FIGS. 3A-3B, the UE 120 may need to first perform a physical random access channel (PRACH) transmission in which a random access preamble is transmitted to the network node 110 to establish uplink timing. Alternatively, in the CG-SDT procedure depicted in FIG. 3C, the UE 120 can reuse an uplink timing advance configured in an RRC connected state, and therefore does not need to perform a PRACH transmission before transmitting the uplink small data. Accordingly, the RA-based SDT procedures may provide the UE 120 with flexibility to change locations or otherwise move within a coverage area of the network node 110 or to the coverage area of a new network node 110, which may improve MO-SDT coverage. However, the RA-based SDT procedures require the UE 120 to spend time establish uplink timing, whereby the CG-SDT procedure may offer a lower latency in cases where the network node 110 receiving the uplink small data is the same network node 110 that the UE 120 was connected to in the RRC connected state.

As indicated above, FIGS. 3A-3C are provided as examples. Other examples may differ from what is described with regard to FIGS. 3A-3C.

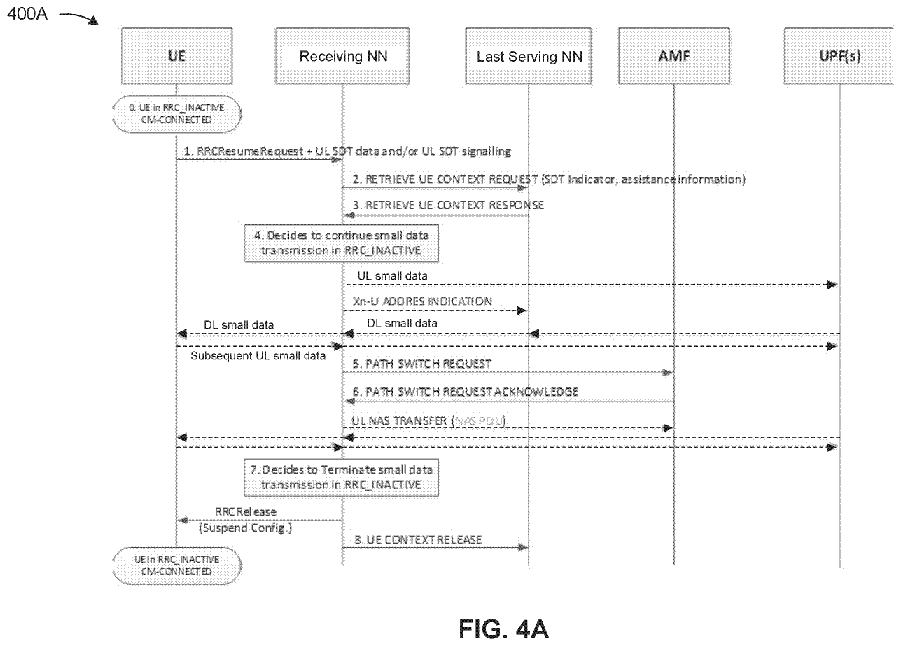

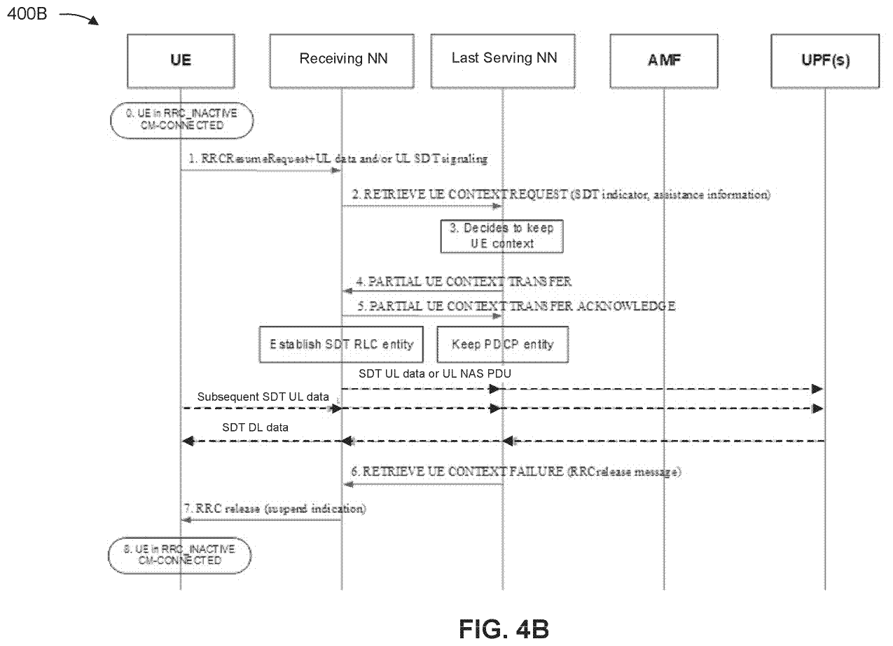

FIGS. 4A-4B are diagrams illustrating examples 400A, 400B of RA-SDT procedures, in accordance with the present disclosure. As shown in FIGS. 4A-4B, examples 400A and 400B include communication between a UE, a receiving network node, a last serving network node, an access and mobility management function (AMF) device, and a user plane function (UPF) device. In some aspects, the UE, the receiving network node, the last serving network node, the AMF device, and the UPF device may be included in a wireless network, such as wireless network 100. The UE may communicate with the receiving network node and/or the last serving network node via a wireless access link, which may include an uplink and a downlink, and the receiving network node and/or the last serving network node may communicate with the AMF device and/or the UPF device via a core network (e.g., using a backhaul interface).

As described above, an RA-based MO-SDT procedure (e.g., as depicted in and described above with reference to FIGS. 3A-3B) may provide a UE with flexibility to change locations or otherwise move within a coverage area of the network node or to the coverage area of a new network node, which may improve MO-SDT coverage. For example, in FIG. 4A and FIG. 4B, the UE may perform an RA-based SDT procedure with a receiving network node (e.g., a network node that receives the uplink small data transmission), which may be different from the last serving network node for the UE.

For example, as shown in FIG. 4A and FIG. 4B, the UE may initiate an RA-based SDT procedure from an RRC inactive or RRC idle state by transmitting an RRC resume request with an uplink SDT and/or uplink SDT signaling (e.g., in a msgA payload of a two-step random access procedure or msg3 of a four-step random access procedure). In examples 400A and 400B, where the network node receiving the uplink small data from the UE is different from the last serving network node, the RA-SDT procedure may include relocating a context of the UE to the receiving network node or the RA-SDT procedure may be performed without relocating the context of the UE to the receiving network node. For example, FIG. 4A depicts an RA-SDT procedure in which the context of the UE is relocated to the receiving network node, where the receiving network node retrieves the context of the UE from the last serving network node. The receiving network node may then decide to continue the RA-based SDT procedure in the RRC inactive or idle state, and may forward the uplink small data to the UPF device. The receiving network node may then provide an Xn-U address indication to the last serving network node (e.g., to enable reception of subsequent downlink small data from the UPF device, which is forwarded to the UE through the last serving network node and the receiving network node). As shown, when subsequent uplink small data is received from the UE, the receiving network node may transmit a path switch request to the AMF device, which may acknowledge the path switch request. Accordingly, a NAS protocol data unit including an uplink NAS transfer may be provided to the AMF device, and subsequent downlink and/or uplink small data transmissions may be performed through the receiving network node. As shown in FIG. 4A, the receiving network node may subsequently transmit an RRC release message with the suspend configuration parameter enabled to the UE to terminate the RA-based SDT procedure and return the UE to the RRC inactive or RRC idle state. The receiving network node may then transmit a message to the last serving network node to release the UE context held at the last serving network node.

Alternatively, example 400B in FIG. 4B depicts an RA-SDT procedure that is performed without relocating the context of the UE to the receiving network node. For example, after transmitting a message to retrieve the context of the UE from the last serving network node, the last serving network node may decide to keep the UE context (e.g., anticipating that the UE may reconnect to the last serving network node). In this case, the last serving network node may transfer a partial context of the UE to the receiving network node, which may transmit a message to the last serving network node to acknowledge the partial UE context transfer. At this point, the last serving network node may maintain a packet data convergence protocol (PDCP) entity for the UE, and the receiving network node may establish an SDT radio link control (RLC) entity. As shown, the receiving network node may then transmit the small uplink data received from the UE and/or an uplink NAS PDU to the last serving network node, which may forward the small uplink data and/or uplink NAS PDU to the UPF device. In this case, because the context of the UE is maintained at the last serving network node, subsequent uplink data transmitted by the UE and/or subsequent downlink data targeting the UE may be routed to or from the UPF device via the receiving network node and the last serving network node. As further shown in FIG. 4B, the last serving network node may subsequently transmit a retrieve UE context failure message (e.g., an RRC release message) to the receiving network node to terminate the RA-based SDT procedure, and the receiving network node may transmit an RRC release message with a suspend indication to the UE to release the UE to the RRC inactive or idle state.

As indicated above, FIGS. 4A-4B are provided as examples. Other examples may differ from what is described with regard to FIGS. 4A-4B.

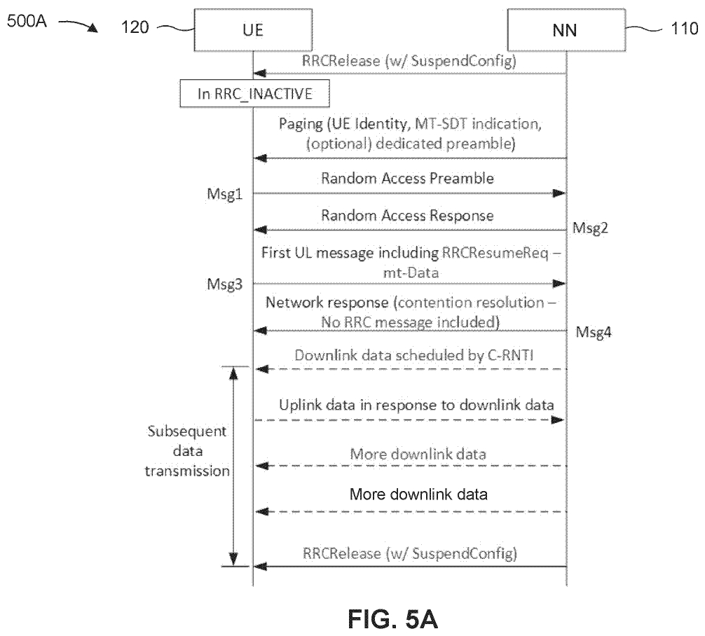

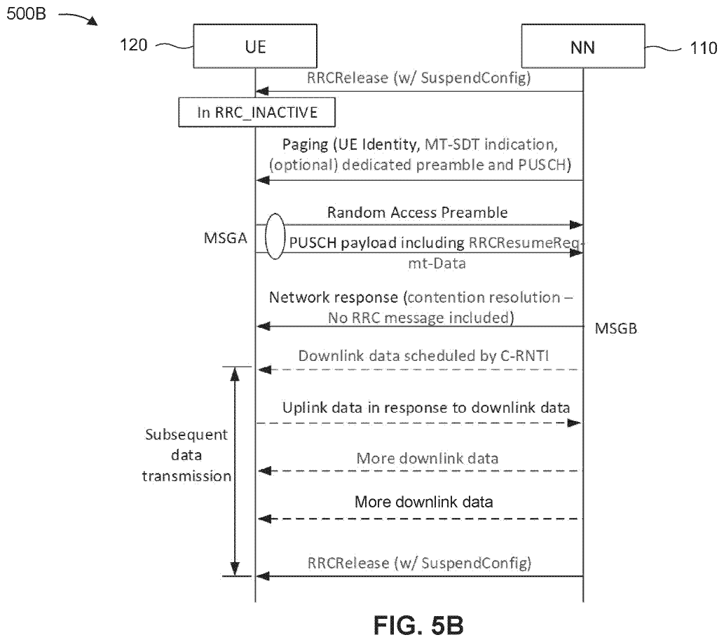

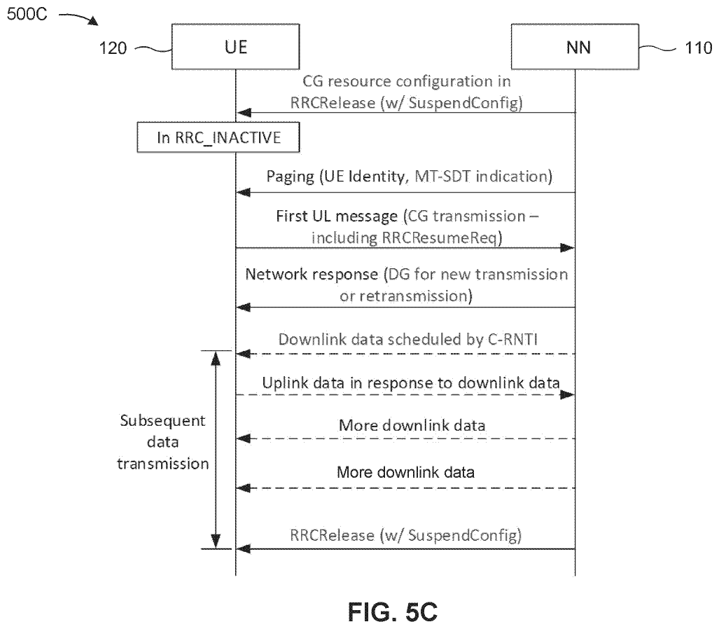

FIGS. 5A-5C are diagrams illustrating examples of mobile-terminated small data transmission (MT-SDT) procedures, in accordance with the present disclosure. As shown in FIGS. 5A-5C, examples 500A-500C include communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As described herein, the network node 110 and the UE 120 may communicate in a wireless network that supports one or more MT-SDT procedures, which generally allow the network node 110 initiate a mobile-terminated downlink small data transmission to the UE 120 while the UE 120 is in an RRC inactive or an RRC idle state without the UE 120 having to transition to an RRC connected state. In general, as described herein, the MT-SDT procedures may be used for initial downlink data reception at the UE 120 and subsequent uplink and/or downlink small data transmissions while when the UE 120 is in the RRC inactive or RRC idle state.

Furthermore, one or more MT-SDT procedures may include a paging-triggered SDT, which may support an MO-SDT procedure (e.g., an RA-SDT procedure and/or a CG-SDT procedure) as an uplink response. For example, as described herein, the network node 110 may transmit a paging message to the UE 120 to indicate that there is downlink small data targeted to the UE 120, and the UE 120 may then receive the downlink small data from the previous serving network node 110 or from a different serving network node 110 within a RAN notification area (RNA) of the UE 120 (e.g., the paging message does not include the downlink small data, but rather indicates to the UE 120 that the downlink small data is available to transmit to the UE 120).

For example, example 500A in FIG. 5A depicts a paging-triggered MT-SDT procedure in which the UE 120 responds to an MT-SDT indication carried in a paging message by initiating a four-step RA procedure (e.g., contention-based random access (CBRA) and/or contention-free random access (CFRA)) or an MO-SDT procedure based on a four-step RA procedure. For example, as shown in FIG. 5A, the network node 110 may transmit an RRC release message to the UE 120 with a suspend configuration parameter enabled, which may cause the UE 120 to transition to the RRC inactive or idle state. In cases where the network node 110 has downlink data to transmit to the UE 120 and the downlink data has a payload size that fails to satisfy (e.g., is less than or equal to a threshold), the network node 110 may transmit a paging message to the UE 120 that includes an identity of the UE and an MT-SDT indication, and optionally further includes a dedicated preamble (e.g., for CFRA). In example 500A, the UE 120 may then transmit a random access preamble in a msg1 communication, and may transmit a first uplink message that includes an RRC resume request and an MT data indication in a msg3 communication after receiving a random access response from the network node. The network node 110 may then transmit a network response including a contention resolution message without an RRC message, and may subsequently transmit downlink data to the UE 120 that is scheduled by a cell radio network temporary identifier (C-RNTI) assigned to the UE 120. As further shown, subsequent data transmissions may include uplink data from the UE 120 in response to the downlink small transmission and/or more downlink data targeting the UE 120. As further shown, the network node 110 may transmit an RRC release message with the suspend configuration parameter enabled to terminate the uplink and/or downlink SDTs.

Alternatively, example 500B in FIG. 5B depicts a paging-triggered MT-SDT procedure in which the UE 120 responds to an MT-SDT indication carried in a paging message by initiating a two-step RA procedure (e.g., via CBRA and/or CFRA) or an MO-SDT procedure based on a two-step RA procedure. For example, as shown in FIG. 5B, the network node 110 may transmit an RRC release message to the UE 120 with a suspend configuration parameter enabled, which may cause the UE 120 to transition to the RRC inactive or idle state. In cases where the network node 110 has downlink data to transmit to the UE 120 and the downlink data has a payload size that fails to satisfy (e.g., is less than or equal to a threshold), the network node 110 may transmit a paging message to the UE 120 that includes an identity of the UE and an MT-SDT indication, and optionally further includes a dedicated preamble and PUSCH resource (e.g., for CFRA). In example 500B, the UE 120 may then transmit a msgA communication that includes a random access preamble and a PUSCH payload carrying an RRC resume request and an MT data indication. The network node 110 may then transmit a network response including a contention resolution message without an RRC message, and may subsequently transmit downlink data to the UE 120 that is scheduled by the C-RNTI assigned to the UE 120. As further shown, subsequent data transmissions may include uplink data from the UE 120 in response to the downlink small transmission and/or more downlink data targeting the UE 120. As further shown, the network node 110 may transmit an RRC release message with the suspend configuration parameter enabled to terminate the uplink and/or downlink SDTs.

Alternatively, example 500C in FIG. 5C depicts a paging-triggered MT-SDT procedure in which the UE 120 responds to an MT-SDT indication carried in a paging message by initiating an MO-SDT procedure based on a CG-PUSCH transmission (e.g., a CG-SDT procedure). For example, as shown in FIG. 5C, the network node 110 may provide a CG resource configuration in an RRC release message transmitted to the UE 120 with a suspend configuration parameter enabled, which may cause the UE 120 to transition to the RRC inactive or idle state. In cases where the network node 110 has downlink small data to transmit to the UE 120, the network node 110 may transmit a paging message to the UE 120 that includes an identity of the UE and an MT-SDT indication. In example 500C, the UE 120 may then transmit a first uplink message using a preconfigured CG-PUSCH resource, where the first uplink message may include an RRC resume request. The network node 110 may then transmit a network response including a dynamic grant for a new downlink transmission or a retransmission, and may subsequently transmit downlink data to the UE 120 that is scheduled by the C-RNTI assigned to the UE 120. As further shown, subsequent data transmissions may include uplink data from the UE 120 in response to the downlink small transmission and/or more downlink data targeting the UE 120. As further shown, the network node 110 may transmit an RRC release message with the suspend configuration parameter enabled to terminate the uplink and/or downlink SDTs.

As indicated above, FIGS. 5A-5C are provided as examples. Other examples may differ from what is described with regard to FIGS. 5A-5C.

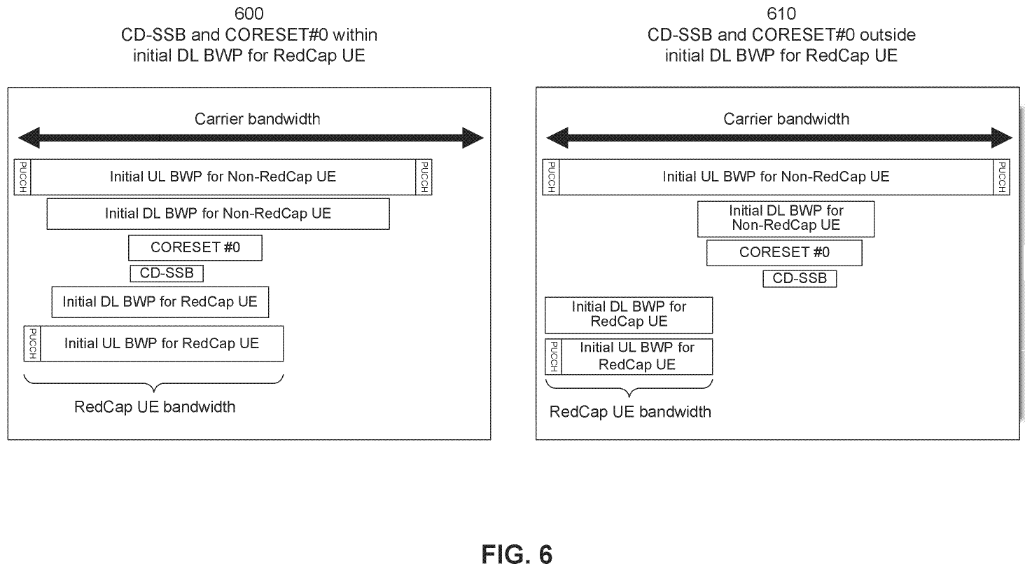

FIG. 6 is a diagram illustrating examples 600, 610 of an initial bandwidth part configuration for a RedCap UE, in accordance with the present disclosure.

For example, in some cases, a network node can serve UEs in different categories and/or UEs that support different capabilities. For example, the network node can serve a first category of UEs that have a less advanced capability (e.g., a lower capability and/or a reduced capability) and a second category of UEs that have a more advanced capability (e.g., a higher capability). A UE of the first category can have a reduced feature set compared to UEs of the second category and can be referred to as a RedCap UE (which may be interchangeably referred to as a reduced-capacity UE, also having the acronym “RedCap”), a low tier UE, and/or an NR-Lite UE, among other examples. For example, a UE of the second category can be an ultra-reliable low-latency communication (URLLC) device and/or an enhanced mobile broadband (eMBB) device and can have an advanced feature set compared to RedCap UEs. RedCap UEs can include wearable devices, IoT devices, sensors, cameras, and/or other devices associated with a limited bandwidth, power capacity, and/or transmission range, among other examples. A UE of the second category can be referred to as a baseline UE, a high tier UE, an NR UE, and/or a premium UE, among other examples. In some aspects, a RedCap UE can have capabilities that satisfy requirements of a first wireless communication standard but not a second wireless communication standard, while a UE of the second category can have capabilities that satisfy requirements of the second wireless communication standard (and also the first wireless communication standard).

For example, a RedCap UE of the first category can support a lower maximum MCS than a UE of the second category (e.g., quadrature phase shift keying (QPSK) or the like as compared to 256-quadrature amplitude modulation (QAM) or the like), can support a lower maximum transmit power than a UE of the second category, can have a less advanced beamforming capability than a UE of the second category (e.g., may not be capable of forming as many beams as a UE of the second category), can require a longer processing time than a UE of the second category, can include less hardware than a UE of the second category (e.g., fewer antennas, fewer transmit antennas, and/or fewer receive antennas), and/or can be not capable of communicating on as wide of a maximum BWP as a UE of the second category, among other examples. A bandwidth part, control channel, search space set, and/or bandwidth or other feature specific to, or otherwise dedicated for use with or by, a RedCap UE can be referred to as “RedCap-specific.” A bandwidth part, control channel, search space set, and/or bandwidth or other feature specific to, otherwise dedicated for use with or by, a non-RedCap UE, and/or is not RedCap-specific, can be referred to as “Non-RedCap-specific.”

Accordingly, in some cases, a network node may configure different initial downlink and/or initial uplink bandwidth parts for a RedCap UE and a non-RedCap UE (e.g., based on a RedCap UE having a maximum bandwidth of 20 MHz for FR1, compared to a maximum carrier bandwidth of 100 MHz for FR1). For example, as shown in FIG. 6, a non-RedCap UE may be configured with an initial uplink bandwidth part and an initial downlink bandwidth part (e.g., by a system information block (SIB) with index one (SIB1)), and a RedCap UE may be configured with a separate initial uplink bandwidth part and/or a separate initial downlink bandwidth part. As shown in example 600 and example 610, the initial downlink bandwidth part that is configured for a non-RedCap UE may include a cell-defining synchronization signal block (CD-SSB) (e.g., an SSB carrying a cell-defining PSS, SSS, and/or physical broadcast channel (PBCH)) and a control resource set (CORESET) with index zero (sometimes referred to as CORESET #0 or CS0, which is configured in a master information block (MIB)). Accordingly, the CD-SSB may be transmitted within the CORESET #0 and the initial downlink bandwidth part configured for non-RedCap UEs.

However, the separate initial downlink bandwidth part configured for a RedCap UE (e.g., by a SIB) may include or may not include the CD-SSB and MIB-configured CORESET #0 (e.g., the initial downlink bandwidth part for a RedCap UE includes the CD-SSB and the MIB-configured CORESET #0 in example 600, but does not include the CD-SSB and the MIB-configured CORESET #0 in example 610). This may pose challenges with respect to SDT procedures, as a UE generally uses resources associated with the CD-SSB and CORESET #0 to perform an MO-SDT procedure and/or an MT-SDT procedure. Accordingly, when a RedCap UE is configured with an initial downlink bandwidth part that does not include the CD-SSB and/or MIB-configured CORESET #0, the RedCap UE may need to switch to the default initial bandwidth part configured for non-RedCap UEs to receive paging messages and/or acquire system information (SI) via the CD-SSB transmitted within CORESET #0 (e.g., a paging common search space (CSS) is not configured for a RedCap UE in the initial downlink bandwidth part without the CD-SSB or CORESET #0). As a result, although MO-SDT procedures and MT-SDT procedures can be used by non-RedCap or RedCap UEs (e.g., any UE can optionally support MO-SDT procedures that include RA-based SDT procedures and CG-SDT procedures and/or MT-SDT procedures), enabling MO-SDT procedures and MT-SDT procedures for both non-RedCap and RedCap UEs may be challenging because the initial downlink bandwidth part configured for a RedCap UE may not include the CD-SSB and/or MIB-configured CORESET #0.

For example, RedCap UEs and non-RedCap UEs that support MO-SDT and/or MT-SDT may generally need be configured with a CORESET and one or more search space sets and one or more downlink reference signals in one or more downlink bandwidth parts. Furthermore, a UE that supports MO-SDT and/or MT-SDT may need be configured with PRACH, PUSCH, and physical uplink control channel (PUCCH) resources in one or more downlink bandwidth parts of a serving network node. In some aspects, as described herein, this may be achieved using a non-cell-defining SSB (NCD-SSB), which can be configured in by a serving cell in a separate initial and/or non-initial (e.g., active) downlink bandwidth part for a RedCap or non-RedCap UE in an RRC idle, inactive, or connected mode (e.g., to assist with measurement procedures by obviating a need to switch to an initial bandwidth part that includes a CD-SSB). For example, the NCD-SSB may enable MT-SDT procedures, which are triggered by RAN paging, because the paging triggering the MT-SDT procedures can be transmitted from multiple network nodes within an RNA of a RedCap UE. For example, as described above with respect to FIGS. 5A-5C, a RAN paging message is generally sent to a UE to trigger or indicate an MT-SDT (e.g., the paging message itself is not an MT-SDT), and the UE has to then send an RRC resume request by RA or an MO-SDT before receiving the MT-SDT (e.g., the network will not send the MT-SDT targeting the UE to the UE until the RRC resume request is received). After sending the RRC resume request message to an anchor network node, the UE may then receive the MT-SDT from one or more serving network nodes within the RNA of the UE (e.g., downlink and/or uplink resources for an MT-SDT targeting the UE can be configured on one or more network nodes within the RNA, and the UE may switch serving network nodes by relocating a context of the UE and/or switching downlink and/or uplink bandwidth parts of the serving network node during an MT-SDT procedure). Furthermore, on a cell that allows access by RedCap UEs, the necessary RA, MO-SDT, and/or MT-SDT resources (e.g., a CORESET and search space set(s), SSB or other downlink reference signal, PRACH, PUSCH, PUCCH, sounding reference signal (SRS), and/or other suitable resources) can be configured on one or more downlink and/or uplink bandwidth parts. Accordingly, as described in further detail herein with reference to FIGS. 7A-7E, FIG. 8, and FIG. 9, some aspects described herein relate to various bandwidth part configurations and/or bandwidth part operations for RedCap and non-RedCap UEs, which may be designed to reduce signaling overhead, improve power saving, and/or increase coverage associated with one or more MO-SDT and/or MT-SDT procedures.

As indicated above, FIG. 6 is provided as an example. Other examples may differ from what is described with regard to FIG. 6.

FIGS. 7A-7E are diagrams illustrating examples 700-780 associated with downlink bandwidth part configurations for SDT procedures of a RedCap UE, in accordance with the present disclosure.

For example, referring to FIG. 7A and FIG. 7B, examples 700-730 depict a downlink bandwidth part configuration that a network node may configure to enable MO-SDT and/or MT-SDT procedures for RedCap and non-RedCap UEs in an RRC inactive or RRC idle mode. For example, as shown in FIGS. 7A-7B, the network node may configure a default initial bandwidth part that is shared by RedCap UEs and non-RedCap UEs, where downlink resources for SI acquisition, paging, RA, MT-SDT, and MO-SDT are configured within the default initial bandwidth part shared by RedCap and non-RedCap UEs. For example, as shown, the downlink resources that are configured within the default initial bandwidth part include a CD-SSB and a MIB-configured CORESET #0. Furthermore, as described herein, the network node may use one or more downlink bandwidth part configurations to configure RedCap UEs with a CORESET and one or more search space sets for SI acquisition, paging, RA, MT-SDT, and MO-SDT. For example, referring to FIG. 7A, example 700 depicts a downlink bandwidth part configuration in which a CORESET and one or more search space sets that are configured for RedCap UEs for SI acquisition, paging, RA, MT-SDT, and MO-SDT are jointly configured with non-RedCap UEs or separately configured within the default initial downlink bandwidth part shared by RedCap and non-RedCap UEs. In this case, because the CORESET and the search space set(s) configured for RedCap UEs includes the CD-SSB, RedCap UEs may use the CD-SSB to perform various activities, such as time and frequency tracking, automatic gain control (AGC), and obtaining Layer 1 (L1) measurements (e.g., RSRP measurements) and/or Layer 3 (L3) measurements (e.g., radio resource management (RRM) measurements).

Additionally, or alternatively, the network node may configure a first CORESET and a first set of one or more search space sets for RedCap UEs to support SI acquisition, paging, MT-SDT procedures, and CG-SDT procedures, and the network node may configure a second CORESET and a second set of one or more search space sets for RedCap UEs to support RA and RA-based SDT procedures. For example, in example 700, the CORESET and search space set(s) configured within the default initial downlink bandwidth part support SI acquisition, paging, RA, MT-SDT procedures, and MO-SDT procedures (which include RA-based SDT procedures and CG-SDT procedures). Alternatively, as shown by examples 710-730, the CORESET and search space set(s) configured in the default initial downlink bandwidth part support only SI acquisition, paging, MT-SDT, and CG-SDT procedures, and the CORESET and search space set(s) that support RA and RA-based SDT procedures for RedCap UEs are configured in a separate (RedCap-specific) initial downlink bandwidth part.

In particular, example 710 in FIG. 7A depicts a downlink bandwidth part configuration in which the CORESET and the search space set(s) that support RA and RA-based SDT procedures for RedCap UEs are configured in a separate initial downlink bandwidth part that includes the CD-SSB but does not include the MIB-configured CORESET #0. In this case, a RedCap UE may use the CD-SSB during an SDT procedure for time and frequency tracking, AGC, L1 and L3 measurements, and/or other activities that rely upon SSB reception or measurement. Alternatively, example 720 in FIG. 7B depicts a downlink bandwidth part configuration in which the CORESET and the search space set(s) that support RA and RA-based SDT procedures for RedCap UEs are configured in a separate initial downlink bandwidth part that includes an NCD-SSB and/or another downlink reference signal (e.g., tracking reference signal (TRS), a channel state information reference signal (CSI-RS), a resynchronization signal (RSS), a low-power wakeup signal (LP-WUS), and/or a positioning reference signal (PRS), among other examples). In this case, a RedCap UE may use the NCD-SSB during an SDT procedure for time and frequency tracking, AGC, L1 and L3 measurements, and/or other activities that rely upon SSB reception or measurement. For example, in some aspects, one or more configurations associated with the NCD-SSB and/or other downlink reference signal (e.g., a radio resource mapping, periodicity, time offset, and/or quasi co-location (QCL) relationship) may be indicated in SI or an RRC configuration, and the presence and time duration of the NCD-SSB and/or resource sets of the other downlink reference signal can be indicated by RRC signaling, a MAC-CE, and/or downlink control information (DCI). Alternatively, example 730 in FIG. 7B depicts a downlink bandwidth part configuration in which the CORESET and the search space set(s) that support RA and RA-based SDT procedures for RedCap UEs are configured in a separate initial downlink bandwidth part that does not include any SSB or downlink reference signal (e.g., there is no CD-SSB, NCD-SSB, TRS, CSI-RS, RSS, LP-WUS, or other downlink reference signal configured in the separate RedCap-specific initial downlink bandwidth part). In this case, a RedCap UE may retune to the default initial downlink bandwidth part and use the CD-SSB during an SDT procedure for time and frequency tracking, AGC, and/or L1 and L3 measurements.

Referring to FIG. 7C, example 740 depicts a downlink bandwidth part configuration in which downlink resources for SI acquisition, paging, RA, MT-SDT procedures, and MO-SDT procedures (including RA-based SDT procedures and CG-SDT procedures) are configured in the separate RedCap-specific initial downlink bandwidth part. In this case, the RedCap-specific initial downlink bandwidth part includes the CD-SSB and the MIB-configured CORESET #0. Accordingly, in some aspects, the CORESET and the search space set(s) that support SI acquisition, paging, RA, MT-SDT procedures, and MO-SDT procedures for RedCap UEs may also be configured in the separate RedCap-specific initial downlink bandwidth part. Accordingly, in example 740, a RedCap UE may use the CD-SSB configured within the separate RedCap-specific initial downlink bandwidth part during an SDT procedure for time and frequency tracking, AGC, L1 and L3 measurements, and/or other activities that rely upon SSB reception or measurement (e.g., the RedCap UE does not need to perform bandwidth part switching because all resources needed to acquire SI, receive paging, initiate RA, and/or perform an MT-SDT or MO-SDT procedure are contained within the separate RedCap-specific initial downlink bandwidth part).

Referring to FIGS. 7D-7E, examples 750-780 depict downlink bandwidth part configurations in which downlink resources for RA, MT-SDT procedures, and MO-SDT procedures are configured in a separate RedCap-specific initial downlink bandwidth part that includes an SSB (e.g., the CD-SSB or an NCD-SSB) and does not include the MIB-configured CORESET #0. Accordingly, in some aspects, the CORESET and the search space set(s) that support SI acquisition and paging can be jointly configured with non-RedCap UEs in the default initial downlink bandwidth part (e.g., as shown by example 750 in FIG. 7D), separately configured within the default initial downlink bandwidth part (e.g., as shown by examples 750 and 760 in FIG. 7D), or configured within the separate RedCap-specific initial downlink bandwidth part (e.g., as shown by examples 770 and 780 in FIG. 7E). Accordingly, when a RedCap UE is operating within the default initial downlink bandwidth part (e.g., in examples 750 and/or 760), the RedCap UE may use the CD-SSB for time and frequency tracking, AGC, L1 and L3 measurements, and/or other activities that rely upon SSB reception or measurement. Alternatively, when a RedCap UE is operating within the separate RedCap-specific initial downlink bandwidth part with an SSB (e.g., in examples 770 and/or 780), the RedCap UE may use the SSB within the separate RedCap-specific initial downlink bandwidth part for time and frequency tracking, AGC, L1 and L3 measurements, and/or other activities that rely upon SSB reception or measurement (e.g., the SSB used by the RedCap UE may be the CD-SSB in example 770 or the NCD-SSB and/or other downlink reference signal in example 780).

As indicated above, FIGS. 7A-7E are provided as examples. Other examples may differ from what is described with regard to FIGS. 7A-7E.

FIG. 8 is a diagram illustrating an example 800 associated with uplink bandwidth part configurations for SDT procedures of a RedCap UE, in accordance with the present disclosure. As shown in FIG. 8, example 800 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As shown in FIG. 8, and by reference number 810, the network node 110 may transmit, to the UE 120, a PUCCH resource configuration on one or more uplink bandwidth parts that support one or more SDT procedures. For example, in cases where the UE 120 supports a paging-triggered MT-SDT procedure (e.g., as described above with reference to FIGS. 5A-5C), the PUCCH resource configuration may indicate that the UE 120 does not need to transmit a hybrid automatic repeat request (HARQ) ACK on a PUCCH to acknowledge reception of a paging indication in one or more uplink bandwidth parts that are configured for an RA procedure, an MT-SDT procedure, or an MO-SDT. Furthermore, in cases where the UE 120 is a RedCap UE that supports one or more MT-SDT procedures, PUCCH resources for the one or more MT-SDT procedures can be jointly configured with other UE types (e.g., non-RedCap UEs and/or RedCap UEs that do not support the one or more MT-SDT procedures).

Additionally, or alternatively, the PUCCH resources for the one or more MT-SDT procedures may be separately configured and/or signaled by SI, RRC signaling, a MAC-CE, and/or DCI. Additionally, or alternatively, PUCCH resources that are configured for RA, MT-SDT, and MO-SDT procedures supported by the UE 120 may be shared (e.g., jointly configured in the same set of radio resources on the same bandwidth part or cell), or PUCCH resources that are configured for RA, MT-SDT, and MO-SDT procedures supported by the UE 120 may be separately configured. In the latter case, where PUCCH resources for RA, MT-SDT, and MO-SDT procedures are separately configured in the same or different bandwidth parts, the network node 110 may signal one or more PUCCH transmission schemes that the UE 120 is to use when performing an RA, MT-SDT, and/or MO-SDT procedure (e.g., inter-slot frequency hopping, intra-slot frequency hopping, PUCCH repetition, PUCCH transmission based on one or more waveforms, PUCCH transmission based on one or more cyclic shifts, and/or a physical resource block (PRB) index at a lower or upper edge of the uplink bandwidth part that is configured with one or more PUCCH resource sets). Alternatively, in cases where the RA, MT-SDT, and MO-SDT procedures supported by the UE 120 share PUCCH resources on the same uplink bandwidth part, the network node 110 may signal a PUCCH transmission scheme that the UE 120 is to use when performing any of the RA, MT-SDT, and MO-SDT procedures.

Furthermore, in some aspects, the PUCCH configuration may indicate whether uplink control information (UCI) multiplexing on a PUCCH or UCI multiplexing with a PUSCH is supported for one or more UCI types (e.g., HARQ feedback, scheduling requests, CSI transmission, and/or assistance information for link adaptation, power saving, or receiver complexity reduction) during an RA, MT-SDT, and/or MO-SDT procedure performed by the UE 120. Furthermore, in some aspects, the PUCCH configuration may indicate whether UCI transmission is prioritized over other downlink channels, uplink channels, downlink signals, and/or uplink signals that overlap in time and/or frequency with the UCI transmission.

As further shown in FIG. 8, and by reference number 820, the network node 110 may transmit, and the UE 120 may receive, a CG-PUSCH resource configuration on one or more uplink bandwidth parts that support one or more SDT procedures. For example, in some aspects, the network node 110 may configure a first CG-PUSCH resource set in a default initial uplink bandwidth part and a second CG-PUSCH resource set in a separate initial uplink bandwidth part configured for the UE 120. Furthermore, in some aspects, the UE 120 may transmit, to the network node 110 (e.g., an anchor or serving network node 110) information to report a preference or a capability of the UE 120 with respect to a bandwidth part configuration and/or bandwidth part switching for one or more MT-SDT procedures and/or one or more MO-SDT procedures. Accordingly, in cases where the network node 110 transmits a paging message with an MT-SDT indication to the UE 120, the paging message may be configured to carry a bandwidth part configuration and/or a bandwidth part switching indication for the UE 120 (e.g., based on the preference or capability signaled by the UE 120).

Accordingly, as shown by reference number 830, the UE 120 may perform one or more SDT procedures and/or other procedures based at least in part on the PUCCH resource configuration and/or the CG-PUSCH resource set configuration provided by the network node 110. For example, in an MT-SDT procedure, the UE 120 may receive an MT-SDT paging indication from the network node 110, and the UE 120 may refrain from transmitting any HARQ feedback to the network node 110 to acknowledge reception of the paging indication. Additionally, or alternatively, the UE 120 may use PUCCH resources that are configured for the SDT procedure, which may be separately configured or jointly configured with other SDT procedures, and/or may use a PUCCH transmission scheme configured for the SDT procedure, which may be separately configured or jointly configured with other SDT procedures. Additionally, or alternatively, when the UE 120 performs a CG-PUSCH transmission for an MO-SDT procedure or an MT-SDT procedure, the UE 120 may perform the CG-PUSCH transmission using a CG-PUSCH resource configured by the network node 110. Furthermore, in cases where the SDT procedure performed by the UE 120 is a (mobile-originated) CG-SDT procedure, the UE 120 may switch to an RA procedure or an RA-based SDT procedure when one or more conditions are satisfied. For example, in cases where the UE 120 is configured with downlink and/or uplink resources for RA, RA-based SDT, and CG-SDT procedures, the UE 120 may trigger a fallback from the CG-SDT procedure to an RA or RA-based SDT procedure if a downlink reference signal is not available for timing advance (TA) validation, a downlink RSRP fails to satisfy a configured threshold for the CG-SDT procedure, a timing alignment timer is expired, a bandwidth part switching indication is received (e.g., in DCI, a MAC-CE, or an RRC message) from the network node 110, an error detection timer for a HARQ procedure of an initial CG-PUSCH transmission is expired, a different serving network node 110 is selected, the UE 120 cannot find valid resources for uplink transmission in the initial uplink bandwidth part of a selected uplink carrier, the UE 120 receives an RRC reject message from the serving network node 110, the UE 120 receives non-SDT data or an indication for non-SDT data, the UE 120 receives a NAS message for a connection management state transition, and/or the UE 120 receives a paging indication for one or more events with a higher priority than the CG-PUSCH transmission. In these and/or other suitable circumstances, the network node 110 may indicate to the UE 120 which bandwidth part that the UE 120 is to switch to in order to perform the RA or RA-based SDT procedure if there is no SSB available for a CG. Alternatively, the UE 120 may select the new bandwidth part to switch to if there is no SSB available for a CG and/or the UE 120 may follow default behavior that is defined in one or more wireless communication standards based on capabilities of the UE 120.

As indicated above, FIG. 8 is provided as an example. Other examples may differ from what is described with regard to FIG. 8.

FIG. 9 is a diagram illustrating an example 900 associated with bandwidth part switching during an SDT procedure of a RedCap UE, in accordance with the present disclosure. As shown in FIG. 9, example 900 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As shown in FIG. 9, and by reference number 910, the UE 120 and the network node 110 may communicate during an MT-SDT procedure and/or an MO-SDT procedure using a first bandwidth part, which may be referred to herein as a current bandwidth part or an active bandwidth part (and which may correspond to a default initial bandwidth part, a RedCap-specific bandwidth part, or another suitable bandwidth part). In some cases, when the UE 120 and the network node 110 are communicating to perform the MT-SDT procedure and/or the MO-SDT procedure, the UE 120 may be allowed to perform bandwidth part switching on a downlink and/or uplink. Additionally, or alternatively, in some cases, the MT-SDT procedure and/or the MO-SDT procedure may involve relocating a context of the UE 120 from a last serving network node 110 to a receiving network node 110 (e.g., as described above with reference to FIG. 4A). Accordingly, as shown by reference number 920, the UE 120 may perform bandwidth part switching and/or serving node reselection during the MT-SDT procedure and/or MO-SDT procedure.

For example, when performing bandwidth part switching from the current or active bandwidth part to a new bandwidth part (e.g., a bandwidth part that is different from the first bandwidth part), the UE 120 may perform the bandwidth part switch during a bandwidth part gap that may be configured during the MT-SDT and/or MO-SDT procedure based on capabilities of the UE 120 and/or resource configurations associated with the MT-SDT and/or MO-SDT procedure. Furthermore, in some aspects, the bandwidth part switching time can be jointly configured with intra-frequency measurement gaps and/or inter-frequency measurement gaps, a paging periodicity, a discontinuous reception (DRX) periodicity, and/or an SDT traffic pattern, among other examples. Furthermore, in cases where the SDT procedure involves relocating the context of the UE 120, the UE 120 may reselect a serving network node 110 within the RNA of the UE 120, and the bandwidth part configurations and/or bandwidth part operations for RA, MT-SDT, and/or MO-SDT procedures in the last serving network node and the current serving network node may be different. For example, the last serving network node 110 and the current serving network node 110 may be associated with bandwidth parts that have different center frequencies, different bandwidths, different numerologies, different reference SSBs and/or other downlink reference signals (e.g., TRS, CSI-RS, RSS, LP-WUS, and/or PRS), different SDT resource configurations for downlink and/or uplink control and/or data channels, and/or different power saving configurations for the UE 120 and/or the network nodes 110 (e.g., different DRX and/or PDCCH monitoring configurations, among other examples). Accordingly, when reselecting the serving network node 110 to perform the MT-SDT and/or MO-SDT procedure, the UE 120 may consider the bandwidth part configurations of the available network nodes 110 and/or other factors, such as cell barring information, BWP and timer configurations for SDT procedures, downlink reference signal configurations and RSRP measurements, and/or capabilities of the UE 120.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120) performs operations associated with bandwidth part operations for SDT procedures of a RedCap UE.

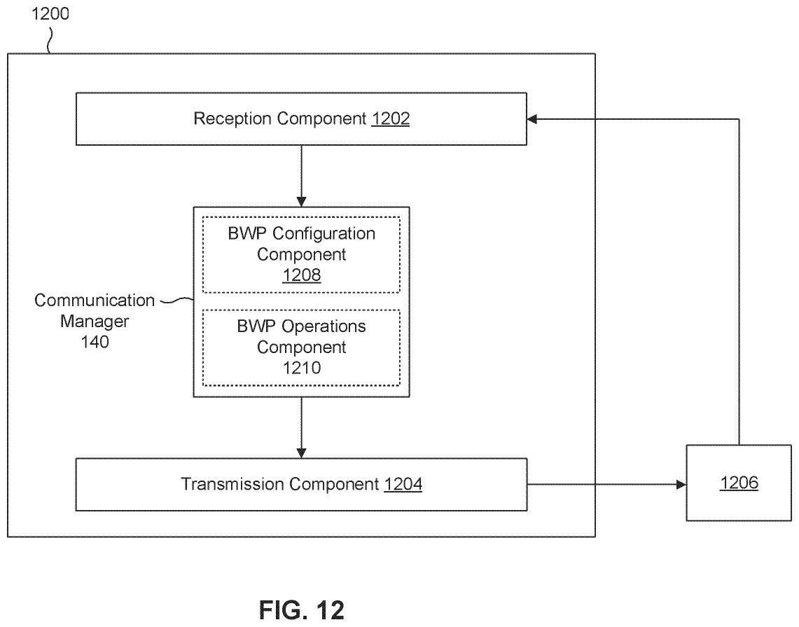

As shown in FIG. 10, in some aspects, process 1000 may include receiving, from a network node, information configuring a default initial downlink bandwidth part, wherein the default initial downlink bandwidth part includes downlink resources that support SDT for RedCap and non-RedCap UEs (block 1010). For example, the UE (e.g., using communication manager 140 and/or reception component 1202, depicted in FIG. 12) may receive, from a network node, information configuring a default initial downlink bandwidth part, wherein the default initial downlink bandwidth part includes downlink resources that support SDT for RedCap and non-RedCap UEs, as described above.

As further shown in FIG. 10, in some aspects, process 1000 may include receiving, from the network node, information configuring a CORESET and one or more search space sets that support SDT for RedCap UEs (block 1020). For example, the UE (e.g., using communication manager 140 and/or reception component 1202, depicted in FIG. 12) may receive, from the network node, information configuring a CORESET and one or more search space sets that support SDT for RedCap UEs, as described above.

As further shown in FIG. 10, in some aspects, process 1000 may include performing, while in an RRC inactive or idle mode, an SDT based at least in part on the information configuring the default initial downlink bandwidth part and the information configuring the CORESET and the one or more search space sets (block 1030). For example, the UE (e.g., using communication manager 140, BWP configuration component 1208, and/or BWP operations component 1210, depicted in FIG. 12) may perform, while in an RRC inactive or idle mode, an SDT based at least in part on the information configuring the default initial downlink bandwidth part and the information configuring the CORESET and the one or more search space sets, as described above.

Process 1000 may include additional aspects, such as any single aspect or any combination of aspects described below and/or in connection with one or more other processes described elsewhere herein.

In a first aspect, the downlink resources supporting SDT in the default initial downlink bandwidth part include a CS0 associated with a CD-SSB.

In a second aspect, alone or in combination with the first aspect, the CORESET and the one or more search space sets support MO-SDT, MT-SDT, SI acquisition, paging, and RA procedures for RedCap UEs and are jointly configured with non-RedCap UEs or separately configured within the default initial downlink bandwidth part.

In a third aspect, alone or in combination with one or more of the first and second aspects, process 1000 includes receiving, from the network node, information configuring a CORESET and one or more search space sets that support an RA procedure and one or more MO-SDT procedures for RedCap UEs within the default initial downlink bandwidth part, a separate initial downlink bandwidth part for RedCap UEs, or a combination thereof.

In a fourth aspect, alone or in combination with one or more of the first through third aspects, process 1000 includes determining a downlink reference signal use when performing one or more activities during the SDT based at least in part on the information configuring the CORESET and the one or more search space sets that support the RA procedure and the one or more MO-SDT procedures for RedCap UEs, wherein the one or more activities include one or more of time and frequency tracking, AGC, or measurements for L1 and L3.

In a fifth aspect, alone or in combination with one or more of the first through fourth aspects, the downlink reference signal is a CD-SSB based at least in part on the CORESET and the one or more search space sets that support the RA procedure and the one or more MO-SDT procedures for RedCap UEs being configured within the default initial downlink bandwidth part.

In a sixth aspect, alone or in combination with one or more of the first through fifth aspects, the downlink reference signal is a CD-SSB based at least in part on the CORESET and the one or more search space sets that support the RA procedure and the one or more MO-SDT procedures for RedCap UEs being configured within the separate initial downlink bandwidth part with the CD-SSB.

In a seventh aspect, alone or in combination with one or more of the first through sixth aspects, the downlink reference signal is a NCD-SSB or another downlink reference signal based at least in part on the CORESET and the one or more search space sets that support the RA procedure and the one or more MO-SDT procedures for RedCap UEs being configured within the separate initial downlink bandwidth part with the NCD-SSB or other downlink reference signal.

In an eighth aspect, alone or in combination with one or more of the first through seventh aspects, the downlink reference signal is a CD-SSB based at least in part on the CORESET and the one or more search space sets that support the RA procedure and the one or more MO-SDT procedures for RedCap UEs being configured within the separate initial downlink bandwidth part without a downlink reference signal.

In a ninth aspect, alone or in combination with one or more of the first through eighth aspects, the CORESET and the one or more search space sets support MO-SDT, MT-SDT, RA, paging and SI acquisition procedures for RedCap UEs and are configured within a separate initial downlink bandwidth part for RedCap UEs.

In a tenth aspect, alone or in combination with one or more of the first through ninth aspects, process 1000 includes receiving, from a network node, information configuring a separate initial downlink bandwidth part including downlink resources that support MO-SDT, MT-SDT, and RA procedures for RedCap UEs, wherein the separate initial downlink bandwidth part includes an SSB and does not include a CS0.

In an eleventh aspect, alone or in combination with one or more of the first through tenth aspects, the CORESET and the one or more search space sets that support SDT for RedCap UEs are configured within the separate initial downlink bandwidth part including the downlink resources that support the MO-SDT and the MT-SDT procedures for RedCap UEs.

In a twelfth aspect, alone or in combination with one or more of the first through eleventh aspects, process 1000 includes receiving, from the network node, a paging indication for an MT-SDT to be performed in the RRC inactive or idle mode, and receiving the paging indication from the network node without transmitting a HARQ ACK on a PUCCH to acknowledge the paging indication in one or more uplink bandwidth parts configured for a RA procedure, an MT-SDT procedure, or an MO-SDT procedure.

In a thirteenth aspect, alone or in combination with one or more of the first through twelfth aspects, PUCCH resources associated with the MT-SDT procedure are jointly configured for RedCap UEs that support the MT-SDT procedure and one or more of RedCap UEs that do not support the MT-SDT procedure or non-RedCap UEs, or separately configured for RedCap UEs that support the MT-SDT procedure.

In a fourteenth aspect, alone or in combination with one or more of the first through thirteenth aspects, PUCCH resources associated with the MT-SDT procedure are configured jointly with PUCCH resources associated with one or more of an MO-SDT procedure or an RA procedure.

In a fifteenth aspect, alone or in combination with one or more of the first through fourteenth aspects, process 1000 includes receiving, from the network node, information indicating a PUCCH transmission scheme separately configured or shared by one or more of the MT-SDT procedure, the MO-SDT procedure, or the RA procedure.

In a sixteenth aspect, alone or in combination with one or more of the first through fifteenth aspects, PUCCH resources associated with the MT-SDT procedure are configured separately from PUCCH resources associated with one or more of an MO-SDT procedure or an RA procedure.

In a seventeenth aspect, alone or in combination with one or more of the first through sixteenth aspects, process 1000 includes receiving, from the network node, information indicating respective PUCCH transmission schemes associated with the MT-SDT procedure, the MO-SDT procedure, and the RA procedure.

In an eighteenth aspect, alone or in combination with one or more of the first through seventeenth aspects, process 1000 includes receiving, from the network node, information configuring a first CG-PUSCH resource set in a default initial uplink bandwidth part and a second CG-PUSCH resource set in a separate initial uplink bandwidth part configured for the UE.

In a nineteenth aspect, alone or in combination with one or more of the first through eighteenth aspects, process 1000 includes transmitting, to the network node, information related to a preference or a capability of the UE for a bandwidth part configuration or bandwidth part switching for an MT-SDT procedure or an MO-SDT procedure that uses the first CG-PUSCH resource set, the second CG-PUSCH resource set, or a combination thereof.

In a twentieth aspect, alone or in combination with one or more of the first through nineteenth aspects, process 1000 includes receiving, from the network node, a paging message that includes an MT-SDT indication, wherein the paging message carries information related to a bandwidth part configuration or bandwidth part switching for an MT-SDT procedure that uses the first CG-PUSCH resource set or the second CG-PUSCH resource set.

In a twenty-first aspect, alone or in combination with one or more of the first through twentieth aspects, process 1000 includes performing a CG-PUSCH transmission for the MO-SDT procedure or the MT-SDT procedure using the first CG-PUSCH resource set or the second CG-PUSCH resource set.

In a twenty-second aspect, alone or in combination with one or more of the first through twenty-first aspects, process 1000 includes triggering a fallback from the CG-PUSCH transmission to an RA procedure or an RA-SDT procedure based at least in part on determining that one or more conditions are satisfied.

In a twenty-third aspect, alone or in combination with one or more of the first through twenty-second aspects, the one or more conditions include no downlink resource being available for timing advance validation, no valid uplink resources being available for PUSCH or PUCCH transmission in an initial uplink bandwidth part of a selected uplink carrier, a downlink reference signal received power failing to satisfy a threshold, a timing alignment timer being expired, an error detection timer for a HARQ procedure of an initial CG-PUSCH transmission being expired, receiving a bandwidth part switching indication from the network node, receiving an RRC reject message from the network node, receiving a NAS message from a core network for a connection management state transition, receiving non-SDT data or an indication for non-SDT data, a different serving network node being selected, or receiving an indication for one or more events with a higher priority than CG-PUSCH transmission.

In a twenty-fourth aspect, alone or in combination with one or more of the first through twenty-third aspects, triggering the fallback from the CG-PUSCH transmission to the RA procedure or the RA-SDT procedure includes switching, based at least in part on a first bandwidth part lacking an available synchronization signal block for the CG-PUSCH transmission, to a second bandwidth part that is indicated by the network node, selected by the UE, or defined based on a capability of the UE, and performing the RA procedure or the RA-SDT procedure in the second bandwidth part with cell re-selection or without cell re-selection.

In a twenty-fifth aspect, alone or in combination with one or more of the first through twenty-fourth aspects, process 1000 includes switching from a first bandwidth part to a second bandwidth part to perform an MT-SDT procedure or an MO-SDT procedure according to a bandwidth part switching gap configured for the UE, wherein the first bandwidth part and the second bandwidth part are configured by the same serving network node or by different serving network modes within an RNA of the UE.

In a twenty-sixth aspect, alone or in combination with one or more of the first through twenty-fifth aspects, the bandwidth part switching gap is configured during the MT-SDT procedure or the MO-SDT procedure based on one or more capabilities of the UE or one or more resource configurations associated with the SDT.

In a twenty-seventh aspect, alone or in combination with one or more of the first through twenty-sixth aspects, the bandwidth part switching gap is configured jointly with one or more measurement gaps, a paging or DRX periodicity, or an SDT traffic pattern.

In a twenty-eighth aspect, alone or in combination with one or more of the first through twenty-seventh aspects, process 1000 includes reselecting a serving network node within an RNA based at least in part on performing the SDT during a procedure that includes relocating a context of the UE, wherein one or more bandwidth part configurations or bandwidth part operations associated with performing the SDT with the reselected serving network node are different from a most recent serving network node.

In a twenty-ninth aspect, alone or in combination with one or more of the first through twenty-eighth aspects, the serving network node is reselected based at least in part on cell barring information, an SDT-related bandwidth part and timer configuration, a downlink reference signal configuration, RSRP measurements, or one or more capabilities of the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with bandwidth part operations for SDT procedures of a reduced capability user equipment.

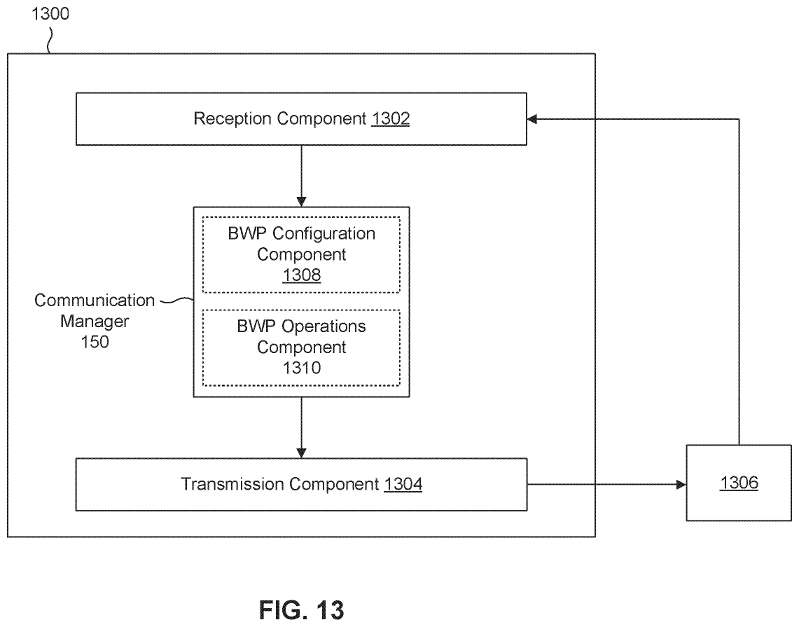

As shown in FIG. 11, in some aspects, process 1100 may include transmitting, to a UE, information configuring a default initial downlink bandwidth part, wherein the default initial downlink bandwidth part includes downlink resources that support SDT for RedCap and non-RedCap UEs (block 1110). For example, the network node (e.g., using communication manager 150 and/or transmission component 1304, depicted in FIG. 13) may transmit, to a UE, information configuring a default initial downlink bandwidth part, wherein the default initial downlink bandwidth part includes downlink resources that support SDT for RedCap and non-RedCap UEs, as described above.

As further shown in FIG. 11, in some aspects, process 1100 may include transmitting, to the UE, information configuring a CORESET and one or more search space sets that supports SDT for RedCap UEs (block 1120). For example, the network node (e.g., using communication manager 150 and/or transmission component 1304, depicted in FIG. 13) may transmit, to the UE, information configuring a CORESET and one or more search space sets that supports SDT for RedCap UEs, as described above.

As further shown in FIG. 11, in some aspects, process 1100 may include communicating with the UE while the UE is performing an SDT in an RRC inactive or idle mode based at least in part on the information configuring the default initial downlink bandwidth part and the information configuring the CORESET and the one or more search space sets (block 1130). For example, the network node (e.g., using communication manager 150, BWP configuration component 1308, and/or BWP operations component 1310, depicted in FIG. 13) may communicate with the UE while the UE is performing an SDT in an RRC inactive or idle mode based at least in part on the information configuring the default initial downlink bandwidth part and the information configuring the CORESET and the one or more search space sets, as described above.

Process 1100 may include additional aspects, such as any single aspect or any combination of aspects described below and/or in connection with one or more other processes described elsewhere herein.

In a first aspect, the downlink resources supporting SDT in the default initial downlink bandwidth part include a CS0 associated with a CD-SSB.

In a second aspect, alone or in combination with the first aspect, the CORESET and the one or more search space sets support MO-SDT, MT-SDT, SI acquisition, paging, and RA procedures for RedCap UEs and are jointly configured with non-RedCap UEs or separately configured within the default initial downlink bandwidth part.

In a third aspect, alone or in combination with one or more of the first and second aspects, process 1100 includes transmitting, to the UE, information configuring a CORESET and one or more search space sets that support an RA procedure and one or more MO-SDT procedures for RedCap UEs within the default initial downlink bandwidth part, a separate initial downlink bandwidth part for RedCap UEs, or a combination thereof.

In a fourth aspect, alone or in combination with one or more of the first through third aspects, the CORESET and the one or more search space sets support MO-SDT, MT-SDT, RA, paging and SI acquisition procedures for RedCap UEs and are configured within a separate initial downlink bandwidth part for RedCap UEs.

In a fifth aspect, alone or in combination with one or more of the first through fourth aspects, process 1100 includes transmitting, to the UE, information configuring a separate initial downlink bandwidth part including downlink resources that support MO-SDT, MT-SDT, and RA procedures for RedCap UEs, wherein the separate initial downlink bandwidth part includes an SSB and does not include a CS0.

In a sixth aspect, alone or in combination with one or more of the first through fifth aspects, the CORESET and the one or more search space sets that support SDT for RedCap UEs are configured within the separate initial downlink bandwidth part including the downlink resources that support the MO-SDT and the MT-SDT procedures for RedCap UEs.

In a seventh aspect, alone or in combination with one or more of the first through sixth aspects, process 1100 includes transmitting, to the UE, a paging indication for an MT-SDT to be performed in the RRC inactive or idle mode, and transmitting the paging indication to UE without configuring transmission of a HARQ ACK on a PUCCH to acknowledge the paging indication in one or more uplink bandwidth parts configured for an RA procedure, an MT-SDT procedure, or an MO-SDT procedure.

In an eighth aspect, alone or in combination with one or more of the first through seventh aspects, PUCCH resources associated with the MT-SDT procedure are jointly configured for RedCap UEs that support the MT-SDT procedure and one or more of RedCap UEs that do not support the MT-SDT procedure or non-RedCap UEs, or separately configured for RedCap UEs that support the MT-SDT procedure.

In a ninth aspect, alone or in combination with one or more of the first through eighth aspects, PUCCH resources associated with the MT-SDT procedure are configured jointly with PUCCH resources associated with one or more of an MO-SDT procedure or an RA procedure.

In a tenth aspect, alone or in combination with one or more of the first through ninth aspects, process 1100 includes transmitting, to the UE, information indicating a PUCCH transmission scheme separately configured or shared by one or more of the MT-SDT procedure, the MO-SDT procedure, or the RA procedure.

In an eleventh aspect, alone or in combination with one or more of the first through tenth aspects, PUCCH resources associated with the MT-SDT procedure are configured separately from PUCCH resources associated with one or more of an MO-SDT procedure or an RA procedure.

In a twelfth aspect, alone or in combination with one or more of the first through eleventh aspects, process 1100 includes transmitting, to the UE, information indicating respective PUCCH transmission schemes associated with the MT-SDT procedure, the MO-SDT procedure, and the RA procedure.

In a thirteenth aspect, alone or in combination with one or more of the first through twelfth aspects, process 1100 includes transmitting, to the UE, information configuring a first CG-PUSCH resource set in a default initial uplink bandwidth part and a second CG-PUSCH resource set in a separate initial uplink bandwidth part configured for the UE.

In a fourteenth aspect, alone or in combination with one or more of the first through thirteenth aspects, process 1100 includes receiving, from the UE, information related to a preference or a capability of the UE for a bandwidth part configuration or bandwidth part switching for an MT-SDT procedure or an MO-SDT procedure that uses the first CG-PUSCH resource set, the second CG-PUSCH resource set, or a combination thereof.

In a fifteenth aspect, alone or in combination with one or more of the first through fourteenth aspects, process 1100 includes transmitting, to the UE, a paging message that includes an MT-SDT indication, wherein the paging message carries information related to a bandwidth part configuration or bandwidth part switching for an MT-SDT procedure that uses the first CG-PUSCH resource set or the second CG-PUSCH resource set.

In a sixteenth aspect, alone or in combination with one or more of the first through fifteenth aspects, process 1100 includes receiving a CG-PUSCH transmission for the MO-SDT procedure or the MT-SDT procedure using the first CG-PUSCH resource set or the second CG-PUSCH resource set.

In a seventeenth aspect, alone or in combination with one or more of the first through sixteenth aspects, process 1100 includes communicating with the UE during an RA procedure or an RA-SDT procedure, wherein a fallback is triggered from the CG-PUSCH transmission to the RA procedure or the RA-SDT procedure based at least in part on one or more conditions being satisfied.

In an eighteenth aspect, alone or in combination with one or more of the first through seventeenth aspects, process 1100 includes switching from a first bandwidth part to a second bandwidth part during an MT-SDT procedure or an MO-SDT procedure with the UE according to a bandwidth part switching gap configured for the UE, wherein the first bandwidth part and the second bandwidth part are configured by the same serving network node or by different serving network modes within an RNA of the UE.

In a nineteenth aspect, alone or in combination with one or more of the first through eighteenth aspects, the bandwidth part switching gap is configured during the MT-SDT procedure or the MO-SDT procedure based on one or more capabilities of the UE or one or more resource configurations associated with the SDT.

In a twentieth aspect, alone or in combination with one or more of the first through nineteenth aspects, the bandwidth part switching gap is configured jointly with one or more measurement gaps, a paging or DRX periodicity, or an SDT traffic pattern.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a network node, or another wireless communication device) using the reception component 1202 and the transmission component 1204. As further shown, the apparatus 1200 may include the communication manager 140. The communication manager 140 may include one or more of a BWP configuration component 1208 or a BWP operations component 1210, among other examples.

In some aspects, the apparatus 1200 may be configured to perform one or more operations described herein in connection with FIGS. 7A-7E, FIG. 8, and/or FIG. 9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive, from a network node, information configuring a default initial downlink bandwidth part, wherein the default initial downlink bandwidth part includes downlink resources that support SDT for RedCap and non-RedCap UEs. The reception component 1202 may receive, from the network node, information configuring a CORESET and one or more search space sets that support SDT for RedCap UEs. The BWP configuration component 1208 and/or the BWP operations component 1210 may perform, while in an RRC inactive or idle mode, an SDT based at least in part on the information configuring the default initial downlink bandwidth part and the information configuring the CORESET and the one or more search space sets.

The reception component 1202 may receive, from the network node, information configuring a CORESET and one or more search space sets that support an RA procedure and one or more MO-SDT procedures for RedCap UEs within the default initial downlink bandwidth part, a separate initial downlink bandwidth part for RedCap UEs, or a combination thereof.

The BWP operations component 1210 may determine a downlink reference signal use when performing one or more activities during the SDT based at least in part on the information configuring the CORESET and the one or more search space sets that support the RA procedure and the one or more MO-SDT procedures for RedCap UEs, wherein the one or more activities include one or more of time and frequency tracking, AGC, or measurements for L1 and L3.

The reception component 1202 may receive, from a network node, information configuring a separate initial downlink bandwidth part including downlink resources that support MO-SDT, MT-SDT, and RA procedures for RedCap UEs, wherein the separate initial downlink bandwidth part includes an SSB and does not include a CS0.

The reception component 1202 may receive, from the network node, a paging indication for an MT-SDT to be performed in the RRC inactive or idle mode.

The reception component 1202 may receive the paging indication from the network node without transmitting a HARQ ACK on a PUCCH to acknowledge the paging indication in one or more uplink bandwidth parts configured for an RA procedure, an MT-SDT procedure, or an MO-SDT procedure.

The reception component 1202 may receive, from the network node, information indicating a PUCCH transmission scheme separately configured or shared by one or more of the MT-SDT procedure, the MO-SDT procedure, or the RA procedure.

The reception component 1202 may receive, from the network node, information indicating respective PUCCH transmission schemes associated with the MT-SDT procedure, the MO-SDT procedure, and the RA procedure.

The reception component 1202 may receive, from the network node, information configuring a first CG-PUSCH resource set in a default initial uplink bandwidth part and a second CG-PUSCH resource set in a separate initial uplink bandwidth part configured for the UE.

The transmission component 1204 may transmit, to the network node, information related to a preference or a capability of the UE for a bandwidth part configuration or bandwidth part switching for an MT-SDT procedure or an MO-SDT procedure that uses the first CG-PUSCH resource set, the second CG-PUSCH resource set, or a combination thereof.

The reception component 1202 may receive, from the network node, a paging message that includes an MT-SDT indication, wherein the paging message carries information related to a bandwidth part configuration or bandwidth part switching for an MT-SDT procedure that uses the first CG-PUSCH resource set or the second CG-PUSCH resource set.

The BWP operations component 1210 may perform a CG-PUSCH transmission for the MO-SDT procedure or the MT-SDT procedure using the first CG-PUSCH resource set or the second CG-PUSCH resource set.

The BWP operations component 1210 may trigger a fallback from the CG-PUSCH transmission to an RA procedure or an RA-SDT procedure based at least in part on determining that one or more conditions are satisfied.

The BWP operations component 1210 may switch from a first bandwidth part to a second bandwidth part to perform an MT-SDT procedure or an MO-SDT procedure according to a bandwidth part switching gap configured for the UE, wherein the first bandwidth part and the second bandwidth part are configured by the same serving network node or by different serving network modes within an RNA of the UE.

The BWP operations component 1210 may reselect a serving network node within an RNA based at least in part on performing the SDT during a procedure that includes relocating a context of the UE, wherein one or more bandwidth part configurations or bandwidth part operations associated with performing the SDT with the reselected serving network node are different from a most recent serving network node.

The number and arrangement of components shown in FIG. 12 are provided as an example. In practice, there may be additional components, fewer components, different components, or differently arranged components than those shown in FIG. 12.

Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a network node, or another wireless communication device) using the reception component 1302 and the transmission component 1304. As further shown, the apparatus 1300 may include the communication manager 150. The communication manager 150 may include one or more of a BWP configuration component 1308 or a BWP operations component 1310, among other examples.

In some aspects, the apparatus 1300 may be configured to perform one or more operations described herein in connection with FIGS. 7A-7E, FIG. 8, and/or FIG. 9. Additionally, or alternatively, the apparatus 1300 may be configured to perform one or more processes described herein, such as process 1000 of FIG. 10. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The transmission component 1304 may transmit, to a UE, information configuring a default initial downlink bandwidth part, wherein the default initial downlink bandwidth part includes downlink resources that support SDT for RedCap and non-RedCap UEs. The transmission component 1304 may transmit, to the UE, information configuring a CORESET and one or more search space sets that supports SDT for RedCap UEs. The BWP configuration component 1308 and/or the BWP operations component 1310 may communicate with the UE while the UE is performing an SDT in an RRC inactive or idle mode based at least in part on the information configuring the default initial downlink bandwidth part and the information configuring the CORESET and the one or more search space sets.

The transmission component 1304 may transmit, to the UE, information configuring a CORESET and one or more search space sets that support an RA procedure and one or more MO-SDT procedures for RedCap UEs within the default initial downlink bandwidth part, a separate initial downlink bandwidth part for RedCap UEs, or a combination thereof.

The transmission component 1304 may transmit, to the UE, information configuring a separate initial downlink bandwidth part including downlink resources that support MO-SDT, MT-SDT, and RA procedures for RedCap UEs, wherein the separate initial downlink bandwidth part includes an SSB and does not include a CS0.

The transmission component 1304 may transmit, to the UE, a paging indication for an MT-SDT to be performed in the RRC inactive or idle mode.

The transmission component 1304 may transmit the paging indication to UE without configuring transmission of a HARQ ACK on a PUCCH to acknowledge the paging indication in one or more uplink bandwidth parts configured for an RA procedure, an MT-SDT procedure, or an MO-SDT procedure.

The transmission component 1304 may transmit, to the UE, information indicating a PUCCH transmission scheme separately configured or shared by one or more of the MT-SDT procedure, the MO-SDT procedure, or the RA procedure.

The transmission component 1304 may transmit, to the UE, information indicating respective PUCCH transmission schemes associated with the MT-SDT procedure, the MO-SDT procedure, and the RA procedure.

The transmission component 1304 may transmit, to the UE, information configuring a first CG-PUSCH resource set in a default initial uplink bandwidth part and a second CG-PUSCH resource set in a separate initial uplink bandwidth part configured for the UE.

The reception component 1302 may receive, from the UE, information related to a preference or a capability of the UE for a bandwidth part configuration or bandwidth part switching for an MT-SDT procedure or an MO-SDT procedure that uses the first CG-PUSCH resource set, the second CG-PUSCH resource set, or a combination thereof.

The transmission component 1304 may transmit, to the UE, a paging message that includes an MT-SDT indication, wherein the paging message carries information related to a bandwidth part configuration or bandwidth part switching for an MT-SDT procedure that uses the first CG-PUSCH resource set or the second CG-PUSCH resource set.

The reception component 1302 may receive a CG-PUSCH transmission for the MO-SDT procedure or the MT-SDT procedure using the first CG-PUSCH resource set or the second CG-PUSCH resource set.

The BWP operations component 1310 may communicate with the UE during an RA procedure or an RA-SDT procedure, wherein a fallback is triggered from the CG-PUSCH transmission to the RA procedure or the RA-SDT procedure based at least in part on one or more conditions being satisfied.

The BWP configuration component 1308 may switch from a first bandwidth part to a second bandwidth part during an MT-SDT procedure or an MO-SDT procedure with the UE according to a bandwidth part switching gap configured for the UE, wherein the first bandwidth part and the second bandwidth part are configured by the same serving network node or by different serving network modes within an RNA of the UE.

The number and arrangement of components shown in FIG. 13 are provided as an example. In practice, there may be additional components, fewer components, different components, or differently arranged components than those shown in FIG. 13.

Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a UE, comprising: receiving, from a network node, information configuring a default initial downlink bandwidth part, wherein the default initial downlink bandwidth part includes downlink resources that support SDT for RedCap and non-RedCap UEs; receiving, from the network node, information configuring a CORESET and one or more search space sets that support SDT for RedCap UEs; and performing, while in an RRC inactive or idle mode, an SDT based at least in part on the information configuring the default initial downlink bandwidth part and the information configuring the CORESET and the one or more search space sets.

Aspect 2: The method of Aspect 1, wherein the downlink resources supporting SDT in the default initial downlink bandwidth part include a CS0 associated with a CD-SSB.

Aspect 3: The method of any of Aspects 1-2, wherein the CORESET and the one or more search space sets support MO-SDT, MT-SDT, SI acquisition, paging, and RA procedures for RedCap UEs and are jointly configured with non-RedCap UEs or separately configured within the default initial downlink bandwidth part.

Aspect 4: The method of any of Aspects 1-3, further comprising: receiving, from the network node, information configuring a CORESET and one or more search space sets that support an RA procedure and one or more MO-SDT procedures for RedCap UEs within the default initial downlink bandwidth part, a separate initial downlink bandwidth part for RedCap UEs, or a combination thereof.

Aspect 5: The method of Aspect 4, further comprising: determining a downlink reference signal use when performing one or more activities during the SDT based at least in part on the information configuring the CORESET and the one or more search space sets that support the RA procedure and the one or more MO-SDT procedures for RedCap UEs, wherein the one or more activities include one or more of time and frequency tracking, AGC, or measurements for L1 and L3.

Aspect 6: The method of Aspect 5, wherein the downlink reference signal is a CD-SSB based at least in part on the CORESET and the one or more search space sets that support the RA procedure and the one or more MO-SDT procedures for RedCap UEs being configured within the default initial downlink bandwidth part.

Aspect 7: The method of any of Aspects 5, wherein the downlink reference signal is a CD-SSB based at least in part on the CORESET and the one or more search space sets that support the RA procedure and the one or more MO-SDT procedures for RedCap UEs being configured within the separate initial downlink bandwidth part with the CD-SSB.

Aspect 8: The method of Aspect 5, wherein the downlink reference signal is a NCD-SSB or another downlink reference signal based at least in part on the CORESET and the one or more search space sets that support the RA procedure and the one or more MO-SDT procedures for RedCap UEs being configured within the separate initial downlink bandwidth part with the NCD-SSB or other downlink reference signal.

Aspect 9: The method of Aspect 5, wherein the downlink reference signal is a CD-SSB based at least in part on the CORESET and the one or more search space sets that support the RA procedure and the one or more MO-SDT procedures for RedCap UEs being configured within the separate initial downlink bandwidth part without a downlink reference signal.

Aspect 10: The method of any of Aspects 1-9, wherein the CORESET and the one or more search space sets support MO-SDT, MT-SDT, RA, paging and SI acquisition procedures for RedCap UEs and are configured within a separate initial downlink bandwidth part for RedCap UEs.

Aspect 11: The method of any of Aspects 1-10, further comprising: receiving, from a network node, information configuring a separate initial downlink bandwidth part including downlink resources that support MO-SDT, MT-SDT, and RA procedures for RedCap UEs, wherein the separate initial downlink bandwidth part includes an SSB and does not include a CS0.

Aspect 12: The method of Aspect 11, wherein the CORESET and the one or more search space sets that support SDT for RedCap UEs are configured within the separate initial downlink bandwidth part including the downlink resources that support the MO-SDT and the MT-SDT procedures for RedCap UEs.

Aspect 13: The method of any of Aspects 1-12, further comprising: receiving, from the network node, a paging indication for an MT-SDT to be performed in the RRC inactive or idle mode; and receiving the paging indication from the network node without transmitting a HARQ ACK on a PUCCH to acknowledge the paging indication in one or more uplink bandwidth parts configured for an RA procedure, an MT-SDT procedure, or an MO-SDT procedure.

Aspect 14: The method of Aspect 13, wherein PUCCH resources associated with the MT-SDT procedure are jointly configured for RedCap UEs that support the MT-SDT procedure and one or more of RedCap UEs that do not support the MT-SDT procedure or non-RedCap UEs, or separately configured for RedCap UEs that support the MT-SDT procedure.

Aspect 15: The method of Aspect 13, wherein PUCCH resources associated with the MT-SDT procedure are configured jointly with PUCCH resources associated with one or more of an MO-SDT procedure or an RA procedure.

Aspect 16: The method of Aspect 15, further comprising: receiving, from the network node, information indicating a PUCCH transmission scheme separately configured or shared by one or more of the MT-SDT procedure, the MO-SDT procedure, or the RA procedure.

Aspect 17: The method of Aspect 13, wherein PUCCH resources associated with the MT-SDT procedure are configured separately from PUCCH resources associated with one or more of an MO-SDT procedure or an RA procedure.

Aspect 18: The method of Aspect 17, further comprising: receiving, from the network node, information indicating respective PUCCH transmission schemes associated with the MT-SDT procedure, the MO-SDT procedure, and the RA procedure.

Aspect 19: The method of any of Aspects 1-18, further comprising: receiving, from the network node, information configuring a first CG-PUSCH resource set in a default initial uplink bandwidth part and a second CG-PUSCH resource set in a separate initial uplink bandwidth part configured for the UE.

Aspect 20: The method of Aspect 19, further comprising: transmitting, to the network node, information related to a preference or a capability of the UE for a bandwidth part configuration or bandwidth part switching for an MT-SDT procedure or an MO-SDT procedure that uses the first CG-PUSCH resource set, the second CG-PUSCH resource set, or a combination thereof.

Aspect 21: The method of any of Aspects 19-20, further comprising: receiving, from the network node, a paging message that includes an MT-SDT indication, wherein the paging message carries information related to a bandwidth part configuration or bandwidth part switching for an MT-SDT procedure that uses the first CG-PUSCH resource set or the second CG-PUSCH resource set.

Aspect 22: The method of any of Aspects 19-21, further comprising: performing a CG-PUSCH transmission for the MO-SDT procedure or the MT-SDT procedure using the first CG-PUSCH resource set or the second CG-PUSCH resource set.

Aspect 23: The method of Aspect 22, further comprising: triggering a fallback from the CG-PUSCH transmission to an RA procedure or an RA-SDT procedure based at least in part on determining that one or more conditions are satisfied.

Aspect 24: The method of Aspect 23, wherein the one or more conditions include no downlink resource being available for timing advance validation, no valid uplink resources being available for PUSCH or PUCCH transmission in an initial uplink bandwidth part of a selected uplink carrier, a downlink reference signal received power failing to satisfy a threshold, a timing alignment timer being expired, an error detection timer for a HARQ procedure of an initial CG-PUSCH transmission being expired, receiving a bandwidth part switching indication from the network node, receiving an RRC reject message from the network node, receiving a NAS message from a core network for a connection management state transition, receiving non-SDT data or an indication for non-SDT data, a different serving network node being selected, or receiving an indication for one or more events with a higher priority than CG-PUSCH transmission.

Aspect 25: The method of any of Aspects 23-24, wherein triggering the fallback from the CG-PUSCH transmission to the RA procedure or the RA-SDT procedure includes: switching, based at least in part on a first bandwidth part lacking an available synchronization signal block for the CG-PUSCH transmission, to a second bandwidth part that is indicated by the network node, selected by the UE, or defined based on a capability of the UE; and performing the RA procedure or the RA-SDT procedure in the second bandwidth part with cell re-selection or without cell re-selection.

Aspect 26: The method of any of Aspects 1-25, further comprising: switching from a first bandwidth part to a second bandwidth part to perform an MT-SDT procedure or an MO-SDT procedure according to a bandwidth part switching gap configured for the UE, wherein the first bandwidth part and the second bandwidth part are configured by the same serving network node or by different serving network modes within an RNA of the UE.

Aspect 27: The method of Aspect 26, wherein the bandwidth part switching gap is configured during the MT-SDT procedure or the MO-SDT procedure based on one or more capabilities of the UE or one or more resource configurations associated with the SDT.

Aspect 28: The method of any of Aspects 26-27, wherein the bandwidth part switching gap is configured jointly with one or more measurement gaps, a paging or DRX periodicity, or an SDT traffic pattern.

Aspect 29: The method of any of Aspects 1-28, further comprising: reselecting a serving network node within an RNA based at least in part on performing the SDT during a procedure that includes relocating a context of the UE, wherein one or more bandwidth part configurations or bandwidth part operations associated with performing the SDT with the reselected serving network node are different from a most recent serving network node.

Aspect 30: The method of Aspect 28, wherein the serving network node is reselected based at least in part on cell barring information, an SDT-related bandwidth part and timer configuration, a downlink reference signal configuration, reference signal received power measurements, or one or more capabilities of the UE.

Aspect 31: A method of wireless communication performed by a network node, comprising: transmitting, to a UE, information configuring a default initial downlink bandwidth part, wherein the default initial downlink bandwidth part includes downlink resources that support SDT for RedCap and non-RedCap UEs; transmitting, to the UE, information configuring a CORESET and one or more search space sets that supports SDT for RedCap UEs; and communicating with the UE while the UE is performing an SDT in an RRC inactive or idle mode based at least in part on the information configuring the default initial downlink bandwidth part and the information configuring the CORESET and the one or more search space sets.

Aspect 32: The method of Aspect 31, wherein the downlink resources supporting SDT in the default initial downlink bandwidth part include a CS0 associated with a CD-SSB.

Aspect 33: The method of any of Aspects 31-32, wherein the CORESET and the one or more search space sets support MO-SDT, MT-SDT, SI acquisition, paging, and RA procedures for RedCap UEs and are jointly configured with non-RedCap UEs or separately configured within the default initial downlink bandwidth part.

Aspect 34: The method of any of Aspects 31-33, further comprising: transmitting, to the UE, information configuring a CORESET and one or more search space sets that support an RA procedure and one or more MO-SDT procedures for RedCap UEs within the default initial downlink bandwidth part, a separate initial downlink bandwidth part for RedCap UEs, or a combination thereof.

Aspect 35: The method of any of Aspects 31-34, wherein the CORESET and the one or more search space sets support MO-SDT, MT-SDT, RA, paging and SI acquisition procedures for RedCap UEs and are configured within a separate initial downlink bandwidth part for RedCap UEs.

Aspect 36: The method of any of Aspects 31-35, further comprising: transmitting, to the UE, information configuring a separate initial downlink bandwidth part including downlink resources that support MO-SDT, MT-SDT, and RA procedures for RedCap UEs, wherein the separate initial downlink bandwidth part includes an SSB and does not include a CS0.

Aspect 37: The method of Aspect 36, wherein the CORESET and the one or more search space sets that support SDT for RedCap UEs are configured within the separate initial downlink bandwidth part including the downlink resources that support the MO-SDT and the MT-SDT procedures for RedCap UEs.

Aspect 38: The method of any of Aspects 31-37, further comprising: transmitting, to the UE, a paging indication for an MT-SDT to be performed in the RRC inactive or idle mode; and transmitting the paging indication to UE without configuring transmission of a HARQ ACK on a PUCCH to acknowledge the paging indication in one or more uplink bandwidth parts configured for an RA procedure, an MT-SDT procedure, or an MO-SDT procedure.

Aspect 39: The method of Aspect 38, wherein PUCCH resources associated with the MT-SDT procedure are jointly configured for RedCap UEs that support the MT-SDT procedure and one or more of RedCap UEs that do not support the MT-SDT procedure or non-RedCap UEs, or separately configured for RedCap UEs that support the MT-SDT procedure.

Aspect 40: The method of any of Aspects 38-39, wherein PUCCH resources associated with the MT-SDT procedure are configured jointly with PUCCH resources associated with one or more of an MO-SDT procedure or an RA procedure.

Aspect 41: The method of Aspect 40, further comprising: transmitting, to the UE, information indicating a PUCCH transmission scheme separately configured or shared by one or more of the MT-SDT procedure, the MO-SDT procedure, or the RA procedure.

Aspect 42: The method of Aspect 38, wherein PUCCH resources associated with the MT-SDT procedure are configured separately from PUCCH resources associated with one or more of an MO-SDT procedure or an RA procedure.

Aspect 43: The method of Aspect 42, further comprising: transmitting, to the UE, information indicating respective PUCCH transmission schemes associated with the MT-SDT procedure, the MO-SDT procedure, and the RA procedure.

Aspect 44: The method of any of Aspects 31-43, further comprising: transmitting, to the UE, information configuring a first CG-PUSCH resource set in a default initial uplink bandwidth part and a second CG-PUSCH resource set in a separate initial uplink bandwidth part configured for the UE.

Aspect 45: The method of Aspect 44, further comprising: receiving, from the UE, information related to a preference or a capability of the UE for a bandwidth part configuration or bandwidth part switching for an MT-SDT procedure or an MO-SDT procedure that uses the first CG-PUSCH resource set, the second CG-PUSCH resource set, or a combination thereof.

Aspect 46: The method of any of Aspects 44-45, further comprising: transmitting, to the UE, a paging message that includes an MT-SDT indication, wherein the paging message carries information related to a bandwidth part configuration or bandwidth part switching for an MT-SDT procedure that uses the first CG-PUSCH resource set or the second CG-PUSCH resource set.

Aspect 47: The method of any of Aspects 44-46, further comprising: receiving a CG-PUSCH transmission for the MO-SDT procedure or the MT-SDT procedure using the first CG-PUSCH resource set or the second CG-PUSCH resource set.

Aspect 48: The method of Aspect 47, further comprising: communicating with the UE during an RA procedure or an RA-SDT procedure, wherein a fallback is triggered from the CG-PUSCH transmission to the RA procedure or the RA-SDT procedure based at least in part on one or more conditions being satisfied.

Aspect 49: The method of any of Aspects 31-48, further comprising: switching from a first bandwidth part to a second bandwidth part during an MT-SDT procedure or an MO-SDT procedure with the UE according to a bandwidth part switching gap configured for the UE, wherein the first bandwidth part and the second bandwidth part are configured by the same serving network node or by different serving network modes within an RNA of the UE.

Aspect 50: The method of Aspect 49, wherein the bandwidth part switching gap is configured during the MT-SDT procedure or the MO-SDT procedure based on one or more capabilities of the UE or one or more resource configurations associated with the SDT.

Aspect 51: The method of any of Aspects 49-50, wherein the bandwidth part switching gap is configured jointly with one or more measurement gaps, a paging or DRX periodicity, or an SDT traffic pattern.

Aspect 52: An apparatus for wireless communication at a device, comprising a processor; memory coupled with the processor; and instructions stored in the memory and executable by the processor to cause the apparatus to perform the method of one or more of Aspects 1-30.

Aspect 53: A device for wireless communication, comprising memory, and one or more processors coupled to the memory, the memory comprising instructions executable by the one or more processors to cause the device to perform the method of one or more of Aspects 1-30.

Aspect 54: A device for wireless communication, comprising a memory and one or more processors coupled to the memory, the one or more processors configured to perform the method of one or more of Aspects 1-30.

Aspect 55: An apparatus for wireless communication, comprising at least one means for performing the method of one or more of Aspects 1-30.

Aspect 56: A non-transitory computer-readable medium storing code for wireless communication, the code comprising instructions executable by a processor to perform the method of one or more of Aspects 1-30.

Aspect 57: A non-transitory computer-readable medium storing a set of instructions for wireless communication, the set of instructions comprising one or more instructions that, when executed by one or more processors of a device, cause the device to perform the method of one or more of Aspects 1-30.

Aspect 58: An apparatus for wireless communication at a device, comprising a processor; memory coupled with the processor; and instructions stored in the memory and executable by the processor to cause the apparatus to perform the method of one or more of Aspects 31-51.

Aspect 59: A device for wireless communication, comprising memory, and one or more processors coupled to the memory, the memory comprising instructions executable by the one or more processors to cause the device to perform the method of one or more of Aspects 31-51.

Aspect 60: A device for wireless communication, comprising a memory and one or more processors coupled to the memory, the one or more processors configured to perform the method of one or more of Aspects 31-51.

Aspect 61: An apparatus for wireless communication, comprising at least one means for performing the method of one or more of Aspects 31-51.

Aspect 62: A non-transitory computer-readable medium storing code for wireless communication, the code comprising instructions executable by a processor to perform the method of one or more of Aspects 31-51.

Aspect 63: A non-transitory computer-readable medium storing a set of instructions for wireless communication, the set of instructions comprising one or more instructions that, when executed by one or more processors of a device, cause the device to perform the method of one or more of Aspects 31-51.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, orany other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving, from a network node, information configuring a default initial downlink bandwidth part, wherein the default initial downlink bandwidth part includes downlink resources that support small data transmission (SDT) for reduced capability (RedCap) and non-RedCap UEs;
receiving, from the network node, information configuring a control resource set (CORESET) and one or more search space sets that support SDT for RedCap UEs; and
performing, while in a radio resource control (RRC) inactive or idle mode, an SDT based at least in part on the information configuring the default initial downlink bandwidth part and the information configuring the CORESET and the one or more search space sets.

2. The method of claim 1, wherein the downlink resources supporting SDT in the default initial downlink bandwidth part include a CORESET with index zero (CS0) associated with a cell-defining synchronization signal block (CD-SSH).

3. The method of claim 1, wherein the COR ESET and the one or more search space sets support mobile-originated SDT (MO-SDT), mobile-terminated SDT (MT-SDT), system information acquisition, paging, and random access procedures for RedCap UEs and are jointly configured with non-RedCap UEs or separately configured within the default initial downlink bandwidth part.

4. The method of claim 1, further comprising:
receiving, from the network node, information configuring a CORESET and one or more search space sets that support a random access procedure and one or more mobile-originated SDT (MO-SDT) procedures for RedCap UEs within the default initial downlink bandwidth part, a separate initial downlink bandwidth part for RedCap UEs, or a combination thereof.

5. The method of claim 4, further comprising:
determining a downlink reference signal to use when performing one or more activities during the SDT based at least in part on the information configuring the CORESET and the one or more search space sets that support the random access procedure and the one or more MO-SDT procedures for RedCap UEs, wherein the one or more activities include one or more of time and frequency tracking, automatic gain control (AGC), or measurements for Layer 1 and Layer 3.

6. The method of claim 5, wherein the downlink reference signal is a cell-defining synchronization signal block (CD-SSB) based at least in part on the CORESET and the one or more search space sets that support the random access procedure and the one or more MO-SDT procedures for RedCap UEs being configured within the default initial downlink bandwidth part within the separate initial downlink bandwidth par with the CD-SSB, or within the separate initial downlink bandwidth part without a downlink reference signal.

7. (canceled)

8. The method of claim 5, wherein the downlink reference signal is a non-cell-defining synchronization signal block (NCD-SSB) or another downlink reference signal based at least in part on the CORESET and the one or more search space sets that support the random access procedure and the one or more MO-SDT procedures for RedCap UEs being configured within the separate initial downlink bandwidth part with the NCD-SSB or other downlink reference signal.

9. (canceled)

10. The method of claim 1, wherein the CORESET and the one or more search space sets support mobile-originated SDT (MO-SDT), mobile-terminated SDT (MT-SDT), random access, paging and system information (SI) acquisition procedures for RedCap UEs and are configured within a separate initial downlink bandwidth part for RedCap UEs.

11. The method of claim 1, further comprising:
receiving, from a network node, information configuring a separate initial downlink bandwidth part including downlink resources that support mobile-originated SDT (MO-SDT), mobile-terminated SDT (MT-SDT), and random access procedures for RedCap UEs, wherein the separate initial downlink bandwidth part includes a synchronization signal block (SSB) and does not include a CORESET with index zero (CS0).

12. (canceled)

13. The method of claim 1, further comprising:
receiving, from the network node, a paging indication for a mobile-terminated SDT (MT-SDT) to be performed in the RRC inactive or idle mode; and
receiving the paging indication from the network node without transmitting a hybrid automatic repeat request (HARQ) acknowledgement (ACK) on a physical uplink control channel (PUCCH) to acknowledge the paging indication in one or more uplink bandwidth parts configured for a random access procedure, a mobile-terminated SDT (MT-SDT) procedure, or a mobile-originated SDT (MO-SDT) procedure.

14-18. (canceled)

19. The method of claim 1, further comprising:
receiving, from the network node, information configuring a first configured grant physical uplink shared channel (CG-PUSCH) resource set in a default initial uplink bandwidth part and a second CG-PUSCH resource set in a separate initial uplink bandwidth part configured for the UE.

20. The method of claim 19, further comprising:
transmitting, to the network node, information related to a preference or a capability of the UE for a bandwidth part configuration or bandwidth part switching for a mobile-terminated SDT (MT-SDT) procedure or a mobile-originated SDT (MO-SDT) procedure that uses the first CG-PUSCH resource set, the second CG-PUSCH resource set, or a combination thereof.

21. The method of claim 19, further comprising:
receiving, from the network node, a paging message that includes a mobile-terminated SDT (MT-SDT) indication, wherein the paging message carries information related to a bandwidth part configuration or bandwidth part switching for an MT-SDT procedure that uses the first CG-PUSCH resource set or the second CG-PUSCH resource set.

22. The method of claim 19, further comprising:
performing a CG-PUSCH transmission for the MO-SDT procedure or the MT-SDT procedure using the first CG-PUSCH resource set or the second CG-PUSCH resource set.

23. The method of claim 22, further comprising:
triggering a fallback from the CG-PUSCH transmission to a random access (RA) procedure or an RA-based mobile-originated SDT (RA-SDT) procedure based at least in part on determining that one or more conditions are satisfied.

24-25. (canceled)

26. The method of claim 1, further comprising:
switching from a first bandwidth part to a second bandwidth part to perform a mobile-terminated SDT (MT-SDT) procedure or a mobile-originated SDT (MO-SDT) procedure according to a bandwidth part switching gap configured for the UE, wherein the first bandwidth part and the second bandwidth part are configured by the same serving network node or by different serving network modes within a radio access network (RAN) notification area (RNA) of the UE.

27. The method of claim 26, wherein the bandwidth part switching gap is configured during the MT-SDT procedure or the MO-SDT procedure based on one or more capabilities of the UE or one or more resource configurations associated with the SDT, or jointly with one or more measurement gaps, a paging or discontinuous reception periodicity, or an SDT traffic pattern.

28. (canceled)

29. The method of claim 1, further comprising:
reselecting a serving network node within a radio access network (RAN) notification area (RNA) based at least in part on performing the SDT during a procedure that includes relocating a context of the UE, wherein one or more bandwidth part configurations or bandwidth part operations associated with performing the SDT with the reselected serving network node are different from a most recent serving network node.

30. (canceled)

31. A method of wireless communication performed by a network node, comprising:
transmitting, to a user equipment (UE), information configuring a default initial downlink bandwidth part, wherein the default initial downlink bandwidth part includes downlink resources that support small data transmission (SDT) for reduced capability (RedCap) and non-RedCap UEs;
transmitting, to the UE, information configuring a control resource set (CORESET) and one or more search space sets that supports SDT for RedCap UEs; and
communicating with the UE while the IE is performing an SDT in a radio resource control (RRC) inactive or idle mode based at least in part on the information configuring the default initial downlink bandwidth part and the information configuring the CORESET and the one or more search space sets.

32. The method of claim 31, wherein the downlink resources supporting SDT in the default initial downlink bandwidth part include a CORESET with index zero (CS0) associated with a cell-defining synchronization signal block (CD-SSB).

33. The method of claim 31, wherein the CORESET and the one or more search space sets support mobile-originated SDT (MO-SDT), mobile-terminated SDT (MT-SDT), system information acquisition, paging, and random access procedures for RedCap UEs and are jointly configured with non-RedCap UEs or separately configured within the default initial downlink bandwidth part.

34. The method of claim 31, further comprising:
transmitting, to the UE, information configuring a CORESET and one or more search space sets that support a random access procedure and one or more mobile-originated SDT (MO-SDT) procedures for RedCap UEs within the default initial downlink bandwidth part, a separate initial downlink bandwidth part for RedCap UEs, or a combination thereof.

35. The method of claim 31, wherein the CORESET and the one or more search space sets support mobile-originated SDT (MO-SDT), mobile-terminated SDT (MT-SDT), random access, paging and system information (SI) acquisition procedures for RedCap UEs and are configured within a separate initial downlink bandwidth part for RedCap UEs.

36. The method of claim 31, further comprising:
transmitting, to the UE, information configuring a separate initial downlink bandwidth part including downlink resources that support mobile-originated SDT (MO-SDT), mobile-terminated SDT (MT-SDT), and random access procedures for RedCap UEs, wherein the separate initial downlink bandwidth part includes a synchronization signal block (SSB) and does not include a CORESET with index zero (CS0).

37. (canceled)

38. The method of claim 31, further comprising:
transmitting, to the UE, a paging indication for a mobile-terminated SDT (MT-SDT) to be performed in the RRC inactive or idle mode; and
transmitting the paging indication to UE without configuring transmission of a hybrid automatic repeat request (HARQ) acknowledgement (ACK) on a physical uplink control channel (PUCCH) to acknowledge the paging indication in one or more uplink bandwidth parts configured for a random access procedure, a mobile-terminated SDT (MT-SDT) procedure, or a mobile-originated SDT (MO-SDT) procedure.

39-43. (canceled)

44. The method of claim 31, further comprising:
transmitting, to the UE, information configuring a first configured grant physical uplink shared channel (CG-PUSCH) resource set in a default initial uplink bandwidth part and a second CG-PUSCH resource set in a separate initial uplink bandwidth part configured for the UE.

45-48. (canceled)

49. The method of claim 31, further comprising:
switching from a first bandwidth part to a second bandwidth pan during a mobile-terminated SDT (MT-SDT) procedure or a mobile-originated SDT (MO-SDT) procedure with the UE according to a bandwidth part switching gap configured for the UE, wherein the first bandwidth part and the second bandwidth part are configured by the same serving network node or by different serving network modes within a radio access network (RAN) notification area (RNA) of the UE.

50. The method of claim 49, wherein the bandwidth part switching gap is configured during the MT-SDT procedure or the MO-SDT procedure based on one or more capabilities of the UE or one or more resource configurations associated with the SDT, or jointly with one or more measurement gas, a paging or discontinuous reception periodicity, or an SDT traffic pattern.

51. (canceled)

52. A user equipment (UE) for wireless communication, comprising:
memory; and
one or more processors coupled to the memory, the memory comprising instructions executable by the one or more processors to cause the UE to:
receive, from a network node, information configuring a default initial downlink bandwidth part, wherein the default initial downlink bandwidth part includes downlink resources that support small data transmission (SDT) for reduced capability (RedCap) and non-RedCap UEs;
receive, from the network node, information configuring a control resource set (CORESET) and one or more search space sets that support SDT for RedCap UEs; and
perform, while in a radio resource control (RRC) inactive or idle mode, an SDT based at least in part on the information configuring the default initial downlink bandwidth part and the information configuring the CORESET and the one or more search space sets.

53-81. (canceled)

82. A network node for wireless communication, comprising:
memory; and
one or more processors coupled to the memory, the memory comprising instructions executable by the one or more processors to cause the network node to:
transmit, to a user equipment (UE), information configuring a default initial downlink bandwidth part, wherein the default initial downlink bandwidth part includes downlink resources that support small data transmission (SDT) for reduced capability (RedCap) and non-RedCap UEs;
transmit, to the UE, information configuring a control resource set (CORESET) and one or more search space sets that supports SDT for RedCap UEs; and
communicate with the UE while the UE is performing an SDT in a radio resource control (RR(C) inactive or idle mode based at least in part on the information configuring the default initial downlink bandwidth part and the information configuring the CORESET and the one or more search space sets.

83-106. (canceled)
